(19) United States
(12) Patent Application Publication
(10) Pub. No.: US 2011/0093243 A1
(43) Pub. Date: Apr. 21, 2011

(54) METHOD FOR MULTI-SCALE MESHING OF BRANCHING BIOLOGICAL STRUCTURES

(76) Inventors: Merryn H. Tawhai, Auckland (NZ); Eric A. Hoffman, Iowa City, IA (US); Ching-Long Lin, Iowa City, IA (US)

(21) Appl. No.: 12/741,526

(22) PCT Filed: Nov. 11, 2008
(86) PCT No.: PCT/US08/83105

§ 371 Date: May 5, 2010

Related U.S. Application Data
(60) Provisional application No. 60/987,844, filed on Nov. 14, 2007.

(51) Int. Cl. G06F 7/60; G06G 7/60

(52) U.S. Cl. 703/2

(57) ABSTRACT

A structural and functional model for a lung or similar organ is virtually defined by encoding aspects of branching passageways. Larger passageways that are visible in medical images are surface mesh fitted to the anatomical surface geometry. Smaller distal passageways, beyond a given number of branch generations, are modeled by inference as linear passages with nominal diameters and branching characteristics, virtually filling the space within the outer envelope of the organ. The model encodes finite volumetric elements for elasticity and compliance in passageway walls, and for local pressure and flow conditions in passageway lumens during respiration. The modeling can assess organ performance, help to plan surgery or therapy, determine likely particle deposition, assess respiratory pharmaceutical dosing, and otherwise represent structural and functional organ parameters.

### CROSS REFERENCE TO RELATED APPLICATION

This application claims the priority of U.S. provisional patent application Ser. No. 60/987,844, filed Nov. 14, 2007, the content of which application is hereby incorporated by reference in its entirety.

### STATEMENT REGARDING GOVERNMENT SPONSORED RESEARCH OR DEVELOPMENT

The subject matter of this disclosure was supported in part by National Institutes of Health (NIH) Bioengineering Research Partnership Grant R01-HL-064368, NIH Grant R01-HL-064368, and NIH Grant R01-EB-005823.

### BACKGROUND OF THE INVENTION

1. Field of the Invention

The invention concerns methods for mathematically representing the structure and function of branching biological structures in data processing models, and programmed systems for applying the models in investigational, diagnostic, therapeutic and similar activities.

2. Related Art

It is possible using magnetic resonance imaging, computed tomography and similar image data collection and image data processing techniques, to obtain images with which to visualize branching biological structures. Examples of branching biological structures include the bronchial airways in the lungs, the arterial or venous vasculature generally or in particular organs, glandular ducts, renal or hepatic structures, etc. Such structures are characterized by relatively more proximal passageways with wider lumens leading to divisions at which relatively narrower distal passageways diverge. The present disclosure is applicable to biological branching structures generally, but a specific branching structure that is discussed as an important but non-limiting example, is the mammalian lung.

Image data collection and image data presentation facilities are known that can accurately depict two dimensional projections of three dimensional structures. An image can be zoomed and rotated, and arbitrary planes can be selected, enabling selection of a succession of views along slice planes. In an interactive system, these abilities permit a viewer to display a virtual fly-through along the lumen of a branching passage. It is also possible using image processing algorithms to map the surfaces that are encountered. See for example WO 2004/027711—Fetita et al., U.S. Pat. No. 6,909,913—Vining, U.S. Pat. No. 6,882,743—Bansal et al., US publications 2007/0071301—Kiraly et al., 2007/0049839—Odry et al.

Although imaging systems are sophisticated and capable, the best image system is of little use if its sole function is to show that a branching biological structure such as a lung is vast and complicated. What is needed is something more than merely to show a complicated branching structure. What is needed is a way to collect, illustrate and manipulate useful information concerning the structure.

It is conceivable that at some future date an imaging system together with an image data processing system might be developed to measure the cross sectional sizes and lengths of all of the branching conduits in an organ such as a lung. This is not possible with today's technology. If the enabling technology did exist, it would still be a formidable computational job to measure all the lung's bronchial airways to the extent necessary to infer pressure and flow comprehensively throughout the lung. What is needed is a set of techniques that are based partly on models and partly on measurements.

Imaging data can be used to create a computational domain for computing fluid dynamics in the airways. Currently the size of the computational domain is constrained by the amount of anatomical information that can be measured from imaging. It would be advantageous to extend the computational domain further into the airway tree, to the regions of lung where particles are most likely to deposit, and where airways are most likely to constrict due to asthma.

A lung or similar branching biological structure may have regular and repeating relationships, such as the relationship between the cross sectional area of a proximal passage and the areas of distal branches proceeding from the passage. The relative length of passages between branches likewise may have observed relationships. As with any biological structure, such relationships exhibit variability. Rules to describe the relationships can be established but typically represent only the average or mean values of factors, ratios, etc. These relationships are on a local scale. Other relationships are on a larger scale (and again exhibit normal and marked variability), such as the normal expectation of lung inflation or air flow capacity as a function of volume. It would be advantageous if relationships on a local level could be exploited to obtain useful information on either a larger dimensional scale or a smaller dimensional scale. One key is to recognize and exploit repeating relationships by which one can infer structural and functional parameters, while also modeling for micro and macro variations from the norm. Another key is to incorporate and seamlessly combine information available in one, two and three dimensions, (1D, 2D, 3D) so as to support efficient modeling and customization of a model to a real biological branching structure, both at the same time.

### SUMMARY OF THE INVENTION

In order to address these and other issues, a method is disclosed herein to create a computational fluid dynamics mesh, beginning from medical imaging on some resolution and proceeding by application of norms and models to relate the medical image data of a real organ, with a set of parameters by which further structural and functional parameters can be inferred.

A set of images is obtained, for example computed tomography (CT) or magnetic resonance (MR) images, representing the branching biological structure, for example the airways or blood vessels within a lung or other organ. Aspects of the image are analyzed to extract information defining one or more surfaces. Branching passageways can be determined in part with reference to structures that can be discerned and in part are inferred from predetermined relationships forming a model. The passageways are to a large extent internal structures that progress from larger less numerous passageways to smaller more numerous passageways due to the branching. The center lines of the internal branching tree are determined from the collected image and by extension are calculated, for example over a given number of branching connections from a discerned inlet/outlet passageway to a lobe or other biological structural unit.

Examples of branching passageway organs include, for example, the lung, brain, and liver. The internal branching structures include airways and vasculature for the lung, and at least vasculature with respect to other organs. In the following text the lung airways are used as an example. The methodology described is equally applicable to other organs.

Having obtained a surface or envelope, a volume mesh of the entire lung or smaller individual anatomical structures (the lobes or bronchopulmonary segments) is geometry-fitted to imaging surface data. The airway center lines branch or bifurcate according to a bifurcating-distributive algorithm. The entire lung can be filled virtually by defining a one dimensional (1D) model airway tree. The CT-located center lines and the model one dimensional tree provide a virtual “scaffold” for further meshing.

The method uses the center line locations and measurements of airway diameter from the CT images (or other image source), including estimated diameters for the one dimensionally modeled airways, to create an initial estimation of a branching mesh, using cylinders to model the elongations of the branches or passageways. A two dimensional (2D) surface mesh is derived to lie over the central scaffold, and a smooth transition structure is inferred at each bifurcation (each branch division). In this way the surface of the entire airway tree can be modeled. Some of the airways, preferably the uppermost airways, are defined by geometry and measurements taken direct from the CT, MR or other imaging input. The structural details defining these airways can be more or less extensive, with accuracy depending on the application of the model. Furthermore, data can be collected that encompasses any number of divisions and passageways. However with each branching, the number of passageways is multiplied and the size of the passageways is reduced. One aspect of the technique is to define airways that are lower (more distal) in the branching pattern, at some level, with geometry controlled by the shape of the lung itself, using modeling rather than measurement or a hybrid of modeling and measurement of at least exemplary biological structural units.

An aspect of this technology is to employ observed biological characteristics of a subject optimally to customize a set of variable parameters of a branching-passage model, so that the model resembles the structure and function of the actual organ. Some of the structural aspects that are included in the variable parameters, and/or aspects that affect the variable parameters and the structure and function of the organ, are inferred by the model and by customization of the model for the individual organ, rather than being observed.

An advantageous object is to facilitate customization of the model of a generalized biological branching structure, so as to reflect the structure of a specific living subject. Customization enables application of subject-oriented tests, including analyzing the effects of predetermined conditions or events on the customized model, for inferring information about the subject whose structures and functions are modeled.

One objective is to minimize the imaging and data processing loads associated with defining the biological structures of a living individual. The parameters of the model for a biological subject are adjusted to match observed aspects of the living individual. In particular, a technique is provided to define parameters of the subject successively, in linear successive cross sectional areas, two-dimensional branches, and three dimensional volumes containing branching passages. The parameters that are then applied as test conditions and/or inferred from the model, can concern pressure, flow, turbulence, particle deposition and the like.

In one embodiment, CT-image defined airway surfaces are geometry-fitted to accurately represent the anatomical structure of the airways from aspects discerned in the imaging. The surface mesh of the entire branching tree (or a selected portion) is interpreted as comprising a volume mesh of incremental volume elements, for example shaped like thick cheese wedges. Each such volume element can be regarded as a distinct unit that is meshed for computational fluid dynamic (CFD) analysis. A finite element grid generator, such as the open source “gmsh” can be used for CFD meshing from the volume elements. See http://geuz.org/gmsh/. Gmsh relies on the definition of bounding surfaces and volumes, hence the division of the airways into small volumes is used within gmsh to control successive meshing of the sub-domains.

Each sub-domain is meshed, with mesh characteristics controlled by the airway size, and following meshing the volumes are recombined. Correct recombination is ensured because the surfaces between adjacent volumes are identical, therefore they share the same triangulation of points on their surface.

The full combined mesh is translated into a format that is suitable for CFD simulation. The knowledge of tree connectivity from the scaffold models as described, allows us to define triangles on the perimeters of the domain. This facilitates specifying boundary conditions for simulation, namely at the perimeters.

Computational fluid dynamics has been used with software meshing for simulating flow patterns and the like, but conventional mesh techniques do not cope well with the complexity of an airway or pulmonary vascular tree. The branching structure of these biological systems introduces challenges. However, it is an aspect of the present disclosure that the definition and calculation of center lines is performed as part of an analysis of the geometry of the airway tree. An inner scaffold is created that ultimately controls the CFD mesh generation. This improves the speed of computation, perhaps completing a useful mesh in a time on the order of hours (for 16 generations of branches), compared with the potential approach of first meshing the airway surface geometry, then filling the surface with a volume mesh, which may take weeks or months. It is an aspect of the scaffold technique that an initial coarse or simplified structure is determined, just from branching characteristics. Then, geometry-fitting captures anatomical detail.

Much of the tedious labor-intensive process of manual editing of the tree is avoided. CFD mesh generation is rapid because by using the center line scaffold, the tree up can be subdivided into smaller sections that are meshed independently—so can be computed on multiple processors simultaneously—then joined back together to make the final mesh. A further aspect is use of a 1D center line tree that is ‘grown’ into an imaging-based definition of the lung geometry as an extra scaffold to extend the CFD mesh into regions of the lung that cannot be imaged.

Although air passages are the lumens within passageway walls, it will be seen that working from the walls inwardly, i.e., from the outside in, is less manageable than working from the inside out. According to the present disclosure, the center lines are considered first, then how the centerlines relate to the surfaces, and then to volumes, and finally to a discretized CFD mesh. A division into concise volumes is possible according to the disclosed technique but is difficult or impossible conventionally, wherein the first step is to define the airway surface by a fine mesh of triangles.

Using the present approach, it is feasible to image and to generate computational fluid dynamic (CFD) meshes customized to mesh a large number and wide range of subjects (animals, human, children) individually based on in vivo imaging. These individuals likewise can be categorized and their data associated with subsets of individuals having aspects in common. The availability of customized branching structure models for a variety of subjects has immediate academic application in understanding inter-subject variability, particularly as to functional characteristics associated with the branching structure, such as air and particle transport in lungs. The subject model data also has potential application as a set of ‘virtual test subjects’ for trials of airway transport and retention of aerosolized medicine and similar studies.

New drugs for respiratory therapies arise infrequently, but real gains in the area of respiratory therapy are possible from improving methods for delivery. This could be via studies involving new external delivery devices, via manipulating the transport characteristics of aerosolized particles, etc. One option for a pharmaceutical company is typically to test drugs and delivery mechanisms in animals. But animals have different airway geometry compared to humans. Translation of results into human physiology can perhaps be facilitated by comparative modeling of human and animal subjects. By providing a service to test drug transport “in silico,” namely in a computer simulation, computer model or computational model, transport in different representative populations can be compared, for example to relate animal studies to expected human results and thus to provide evidence to advance a drug to human trials.

The disclosed method is a particular refinement of the field of computational fluid dynamic meshing, which normally does not substantially constrain or analyze air flow in extensive branching structures. Prior art publications in this area are generally limited to a few airways, possibly up to about 20 at most. The present technologies permit the analysis of simulated flow through a much larger domain. The larger domain includes the customized model that can be generated by inferring aspects of the larger domain from a limited set of images and measurements.

### BRIEF DESCRIPTION OF THE DRAWINGS

There are shown in the drawings embodiments of the invention as presently preferred. It should be understood that the invention is not limited to the arrangements shown in the drawings and is capable of variation within the scope of the claims defining the invention. In the drawings,

FIG. 1 is an overall schematic showing the generation of lung modeling information from CT scan image data for determining a branching pathway structure from a limited set of measurements using computer data processing.

FIGS. 2a through 2d are schematic illustrations showing the progress of certain model method steps. In FIG. 2a, a 1D skeletonization for CT imaged airways is commenced by translating the CT image into a 1D mesh of nodes and linear line elements. FIG. 2b shows the 1D skeletonization mesh including surface locations for tapering linear cylinders around the linear elements as centerlines. The initial cylindrical diameter for a branch segment is the mean of diameter measurements made orthogonal to the centerline on the CT image. In FIG. 2c, an initial surface mesh is provided from the tapering linear cylinders, with three cylinders merging at each branch division (bifurcation). A generic bifurcation mesh is scaled and rotated to merge with proximal and distal mesh components. FIG. 2d shows the geometry fitted surface mesh, where surface curvature is described using high order basis functions (shown here with bi-cubic Hermite). The surface and centerlines are joined to created large volume elements. The fitted surface is discretized to derive a fine-scale mesh, e.g., using triangles, and the sub-volumes are filled virtually using a volume mesh of, for example of tetrahedra.

FIGS. 3a and 3b are output illustrations showing solutions for two different boundary conditions that span a pressure difference, with corresponding flow variations shown by shaded areas. FIGS. 3c and 3d are output illustrations showing solutions for particle deposition concentrations, limited to the modeled airways visible in a CT image. Larger particles (10 μm particle deposition being shown FIG. 3c) tend to be deposited in larger proximal airways. Smaller particles (1 μm particle deposition being shown FIG. 3d) may remain entrained to be deposited in smaller airways that can be modeled mathematically as described herein but may not even be discernable in a CT image.

FIG. 4 is a flow chart summarizing the image and data processing steps for progressing from collection of a CT scan image as shown in FIG. 1, to a computed flow simulation as shown in FIG. 3.

FIGS. 5 through 12 are more detailed illustrations of steps associated with the process shown in FIG. 4.

FIG. 5 is a flow chart showing steps from collection of an image to generation of a 1D skeleton and a volume envelope for a branching biological structure such as a human lung. Volume-bounding surfaces define the envelope of a lung or lobe, and visible (generally larger) airways are defined as proximal passages from which branching proceeds.

FIG. 6 is a flowchart showing application of geometry to fit a volumetric finite element mesh to the lung and/or lobes.

FIG. 7 is a flowchart showing defining one dimensional (1D) connectivity for the junctions of passageways proceeding from a proximal passage. The most proximal passages can be the esophageal passages, the trachea, the primary and secondary bronchi or selected bronchioles, etc. This part of the process produces identifiable passageways having only lengths and junctions with more proximal and more distal passageways.

FIG. 8 is a flowchart showing generating a 1D model from the trachea to the terminal bronchioles within the volume mesh, starting from the 1D connectivity discerned from the CT image and continuing with structures inferred according to programming where the structures are not readily discerned. This process includes defining airway diameters.

FIG. 9 is a flowchart showing generating a 2D surface to encompass the 1D mesh, including use of scaling nodes to smooth the transitions at junctions.

FIG. 10 is a flowchart showing steps for making a geometric fit for the 2D surface mesh to the observed uppermost imaged airways.

FIG. 11 is a flowchart showing filling at least a selected subset of the airways with a 3D volumetric mesh. In one example, the volumetric elements are tetrahedral volumes that abut and thereby fill the modeled volumes.

FIG. 12 is a flowchart showing simulating soft tissue mechanics to calculate boundary conditions. From this point, simulations are possible with varied conditions, to test hypotheses, to compare the lung function of different populations and generally to exercise the model of the lung.

FIG. 13 is a flowchart showing an exemplary application, namely evaluating changes in airway function before and after conducting a clinical trial.

FIG. 14 is a flowchart showing another exemplary application, namely comparing the function of two modeled lungs, such as a human and animal lung, and inferring differences that are pertinent to assessing the delivery of pharmacological substances in aerosol form, or determining the effects of airborne particles.

FIG. 15 is a flowchart demonstrating another exemplary application, namely discriminating among or selecting among subjects for a clinical trial as a function of aspects of lung function.

FIG. 16 is a flowchart showing use of the disclosed techniques for tailoring the design or dosing regimen of a drug to an individual or to a subset of the population having distinct characteristics.

### DETAILED DESCRIPTION OF PREFERRED EMBODIMENTS

A biological branching structure such as a human lung or lobe, comprises larger and smaller passageways affecting the characteristics of the organ for its nominal functions, including respiration, heat exchange, evaporation, deposition of airborne particles, discharge of more or less viscous material and particulates with coughing, allergic reactions, inflammation and other specific functions and effects. It is desirable to study the relationship of structure and function and to exploit the conclusions that can be gleaned in that way.

With computed tomography or magnetic resonance imaging, it is possible to measure the air passages in a local area of the lung or other branching structure. Although there are relatively few passageways at the trachea, bronchi and proximal branching passageways, every generation of branching divisions multiplies the number of passageways. After a number of generations of branching, it becomes a formidable task to measure and account for the lengths, diameters, directions and other characteristics that affect flow in the passageways.

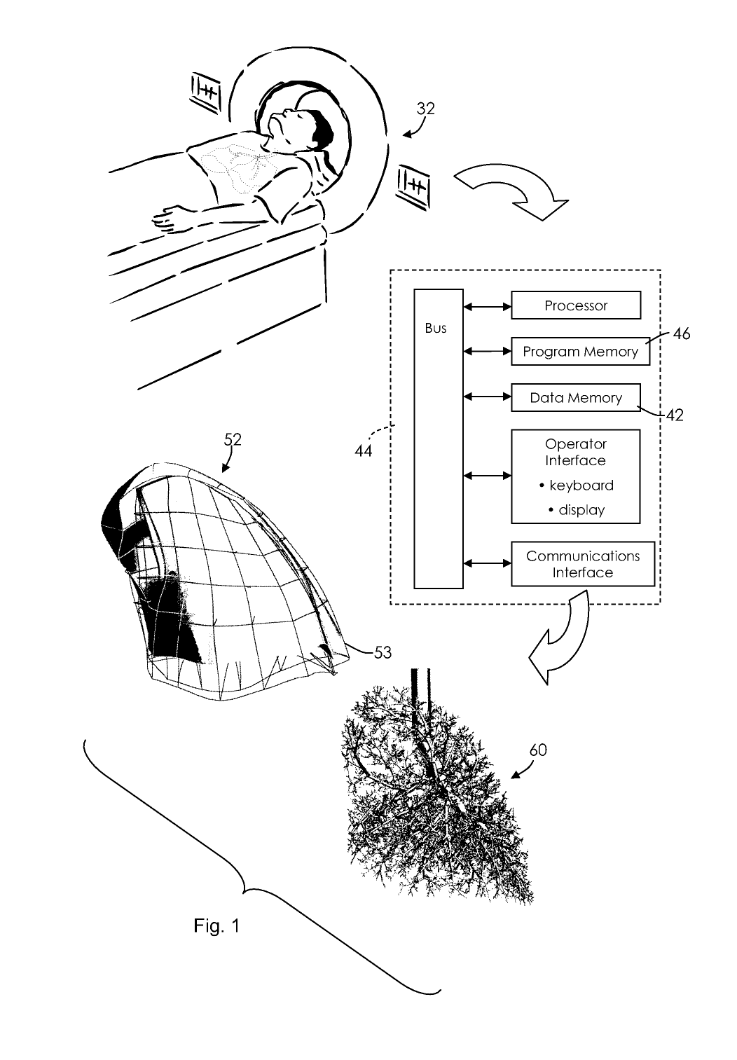

Referring to FIG. 1, a computational methodology is provided and applied in a number of ways that permit the more proximal passageways and also the external or overall volume of at least a subset for the biological structure to be discerned and measured from imaging data. The measurements are applied as inputs to a computational model running on a data processor. Proceeding from the passageways that are discernable by imaging onward into smaller passageways whose structures are not directly discerned and instead are inferred, the data processor relates together and thereby seamlessly couples a one-dimensional (1D) model, simply comprising branching characteristics, through further development into a two dimensional (2D) model with divergent passageway orientations and curves, and then further into a three-dimensional (3D) model wherein the passageway diameters and surfaces are defined over transitions. The result is a three dimensional model, based partly on observation and partly on inference, on which computational fluid dynamics problems are run to develop useful data respecting the functioning of the organ.

The three-dimensional model, relying on the two dimensional and one-dimensional skeletons, is useful to model airways, vascular structures, endocrine ducts and the like. The techniques as described herein teach and enable: (1) generation of a complete geometric model for the full conducting airway tree in an imaged subject, comprising on average 16 generations of adjacent branching passageways and more than 60,000 airway segments, and/or automatic generation of a pulmonary vascular arterial or venous tree of similar magnitude, or automatic generation of a 3D-1D biological tree structured model within an organ; (2) post-processing and graphical display of results; and (3) application of physiological boundary conditions for examining the simulated effects of changes on the branching structure and their consequent effects on functioning of the organ.

The disclosed methodology allows any selected paths of interest to be identified and meshed in relatively greater detail than other paths. Thus, a particular physiological subset can be measured and modeled in full 3D detail, leaving other paths of the organ, which may affect boundary conditions and functioning, as less extensively modeled 1D or 2D meshes. This technique is computationally efficient and practical.

The potential applications of the coupled model include, but are not limited to, enhancement of pharmaceutical drug design, design of medical devices for e.g. drug delivery or supported ventilation, prediction of subject-specific regional ventilation for diagnosis of patterns related to pathologic changes in airway geometry and parenchyma (important, for example, in selective placement of endobronchial valves), study of the dynamics of airflow and its distribution through diseased lungs, study of the dynamics of perfusion and how it is altered by blood pressure and/or vasodilation, study of inert gas transport in the lungs for medical imaging (of interest to manufacturers of medical imaging devices), and study of lung function under zero or high gravity conditions (aviation industry/military, or drug delivery via self-contained breathing apparatus), among others.

The disclosed techniques improve the speed for meshing complex branching biological geometries such as airways, vasculature and/or ducts, enables meshing of a previously unattainable number of passageways, especially airways or blood vessels that branch extensively through numerous generations, allows application of physiologically realistic boundary conditions in computational fluid dynamics simulations (especially applicable to disease studies) and application of realistic surface pressures on blood vessels and airways. The techniques also vastly improve post-processing capability.

As illustrated in FIG. 1, the present technique involves obtaining image data for a branching structure such as a human lung or other organ containing branching passageways, preferably using a magnetic resonance imaging (MRI) or computer tomography (CT) scan device 32. A volumetric image defining variations in tissue type or density produces a three dimensional array of volume element data values or voxels. The image can be displayed to an operator (not shown) for encoding the apparent positions of branches in the passageways, and resolved to passageway lengths and junctions stored in the data memory 42 of a digital computer 44. For this purpose, the computer 44 has a processor, program memory 46, an operator interface including the display and an appropriate communications interface coupled by a data bus. The computer can be coupled directly to the MRI/CT scan apparatus or in communication over a network or can be offline.

Using the MRI/CT scan images as the reference source, images which are of full conventional resolution and full biological complexity, a series of measurements are taken. These measurements include the external envelope 52 of the biological structure and measurements that are used to define passageways within the structure. The external envelope is matched to a three dimensional set of surface points joined to define in the data memory 42 of the computer 44 a virtual surface mesh 53. Defining a three dimensional or external surface requires marking of surface points in a two dimensional projection followed by rotation of the point of view to another reference, so as to discern the surface. Alternatively, the voxel data can be referenced to identify voxels corresponding to the surface, and relative positions determined by voxel positions in a three dimensional data matrix stored in data memory 42.

The measurements taken from the biological image also include a set of measurements that virtually define a subset of the passageways in the branching biological structure, such as the airways in the lung shown as examples. It is impractical to carry virtual representation of the actual biological passageways entirely from the esophagus or trachea through all the bronchi and bronchioles to the most distal alveolar sacs. However as shown in FIG. 1, sufficient information is collected to enable virtual modeling of a portion of interest, typically from the bronchi through at least several generations of branching. The more distal passageways and branches are modeled mathematically for nominal characteristics but are not routinely modeled unless the particular study is taken to micro analysis of a limited volume of the overall organ. It is an aspect that virtual modeling can be applied specifically to a portion between the more proximal and larger passageways to the more distal and numerous smaller passageways, without the need to model all the passageways from the most proximal to most distal extremes. The modeled passageways can be represented in the data memory 42, and/or an image 60 can be rendered, depicting a selected number of successive branches or generations.

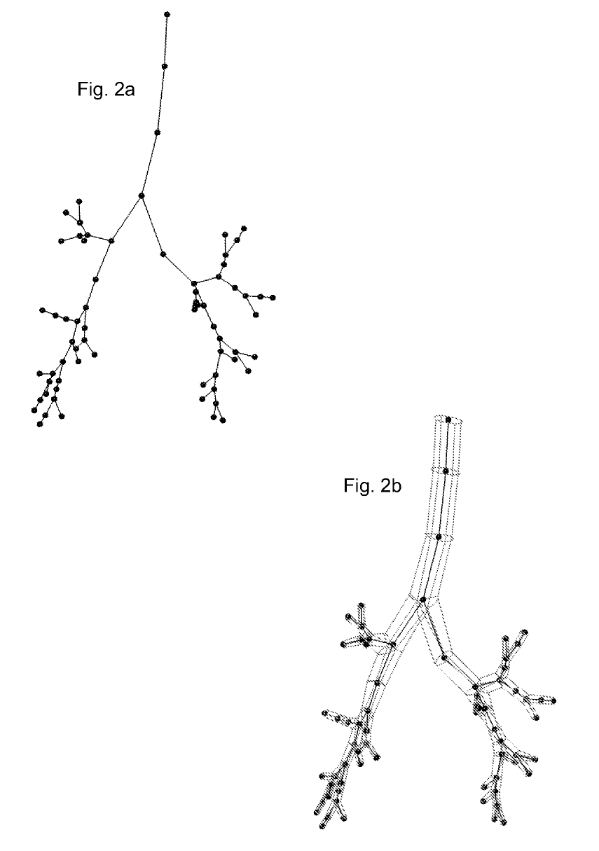

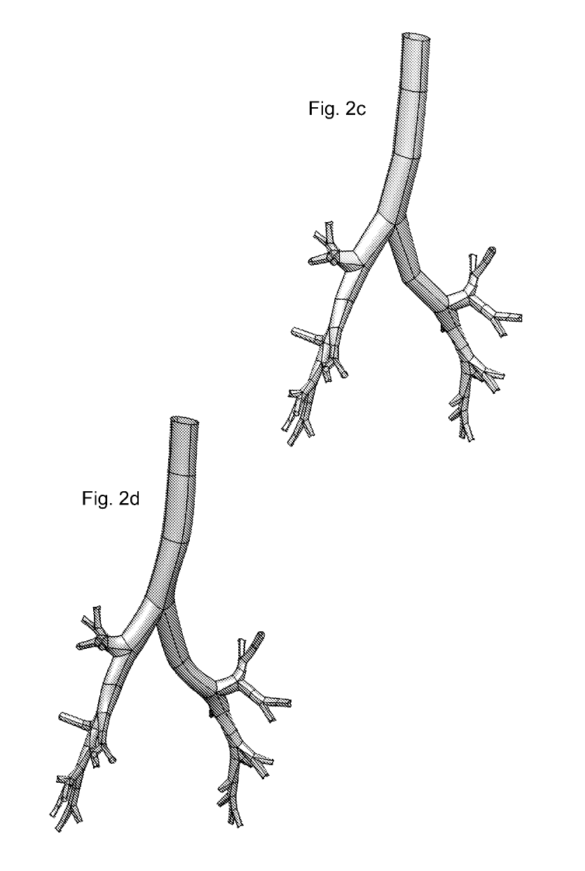

FIGS. 2a-2d illustrate the technique of defining the relationship of adjacent branching passageways in different degrees of spatial detail. In connection with a virtual image, defining some generations of branching using a less detailed spatial representation relieves a great deal of computational overhead, while reserving the possibility to define the flow characteristics of passageways mathematically using nominal flow and pressure characteristics. The generations that are numerous and small in size can be defined only in this mathematical way. The generations at larger and more proximal positions in the branching structure can be defined using more detailed spatial representations, that are exploited where computational fluid dynamics analysis requires consideration of the shapes and relative sizes of passageways, i.e., where modeling is to be more detailed than is capable via one dimensional equations.

FIGS. 2a through 2d are schematic illustrations showing the progress of certain model method steps and also comparing the extent of spatial definitions at the 1D skeleton stage up to fully geometry fitted definition. In FIG. 2a, a 1D skeletonization for CT imaged airways is commenced by translating a set of adjacent passageways that are discernable in a CT image into a 1D mesh of nodes and linear line elements. FIG. 2b shows the 1D skeletonization mesh including surface locations for tapering linear cylinders around the linear elements as centerlines. The initial cylindrical diameter for a branch segment in a passageway discernable in the CT image is the mean of diameter measurements made orthogonal to the passageway centerline on the CT image.

In FIG. 2c, the foregoing characterizations of the passageway structure are refined, producing an initial surface mesh from the tapering linear cylinders, with three cylinders merging at each branch division (bifurcation). A generic bifurcation mesh is scaled and rotated to merge with proximal and distal mesh components. Finally, in FIG. 2d a geometry fitted surface mesh is defined, wherein surface curvature is described using high order basis functions (shown here with bi-cubic Hermite). The surface and centerlines are joined to created large volume elements. The fitted surface is discretized to derive a fine-scale mesh, e.g., using triangles, and the sub-volumes are filled virtually using a volume mesh of, for example of tetrahedra.

Only those passageways that are of a position of interest in the branching hierarchy of passageways need to be modeled to the extent of complete volumetric definition of size, shape and flow. However, pressure and flow conditions at such passageways are affected by pressure and flow conditions at passageways that are more proximal (if any) and also passageways that are more distal. These other passageways, and especially the smaller passageways that are not discernable in a CT image, can be defined exclusively by inferred mathematical characteristics derived from the repetitive nature of the particular biological branching structure, carrying forward down to the smallest terminal passageways. In short, the characteristics of the smaller passages coupled to the distal ends of the fully modeled passages, are modeled as nominal passageway structures filling the external envelope of the lung or other branching structure organ.

In data memory, the branching passageways in the 1D characterization can be identified by nodes or junctions with one another and connecting lengths between such nodes or junctions. The branch leading up to a node and the branches emanating onward have a nominal relative size relationship. Therefore, a model of branches of a given length between branches and a give relationship of diameters allows modeling of the pressure and fluid characteristics of the defined lengths and branches, even though such modeling may not be based on matching the model to specific shapes of the passageways and junctions. Instead, modeling smaller passageways at the skeleton level of detail can be approximate.

For a subset of the branching passageways, such as the passageways proceeding through several branching generations from a given bronchiole, a further level of detail is possible by calculating the two dimensional (2D) surfaces in 3D space that are located one radius distance from the 1D centerline model locations. At the bifurcations or junctions of branches, the 2D surfaces join along the curve of intersection of circular cylinders, each with a unique specified radius.

In that subset or in a still smaller subset of the passageways, the lateral size of the passageways is encoded as mesh defined surfaces with two dimensional (2D) surface encoding in three dimensional (3D) space, and associated variations in shape and internal dimensions for the lumens of the passageways, such as internal diameter or cross sectional internal shape. The surface nodal locations and curvature are calculated to minimize the distance between the 2D model surface and imaging-based measurements of the anatomical surface location. As shown in FIG. 2d, the result is a model that represents the biological structure from data. The model may be at least partly idealized by mathematical approximations. Among others, the approximations include inferring a biologically typical smooth transition from the larger proximal passageways to the smaller divergent next adjacent passageways, in a manner similar to the coping of cylindrical pipe conduits that are joined at angles. However, the model at this level of detail is useful as a set of structures and relationships that define a conduit structure confining air flow and pressure, and preferably varying resiliently and elastically to model the characteristics of the natural organ.

The passageway walls and the lumens of the passageways are modeled (defined mathematically) by a set of volume elements such as tetrahedrons, wedges or the like that abut one another at every position in the modeled volume. Immediately adjacent surfaces of the volume elements include surfaces disposed at surfaces of the passageways, both internal and external. The internal surfaces of the defined passageways model the biological air flow passageways. The elements between the internal and external surfaces define the branching structures and can be modeled to represent elasticity to account for inflation under pressure and other characteristics.

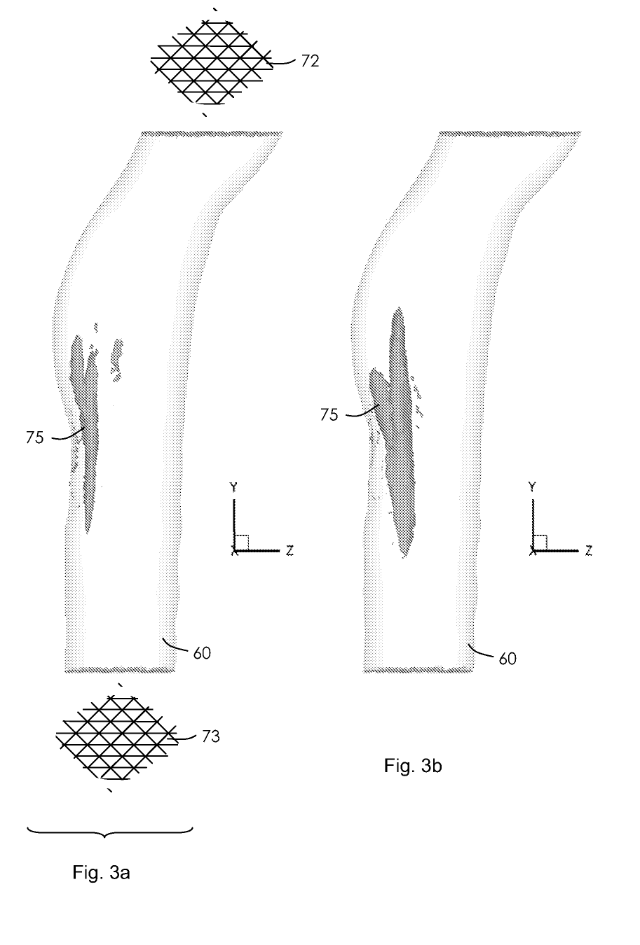

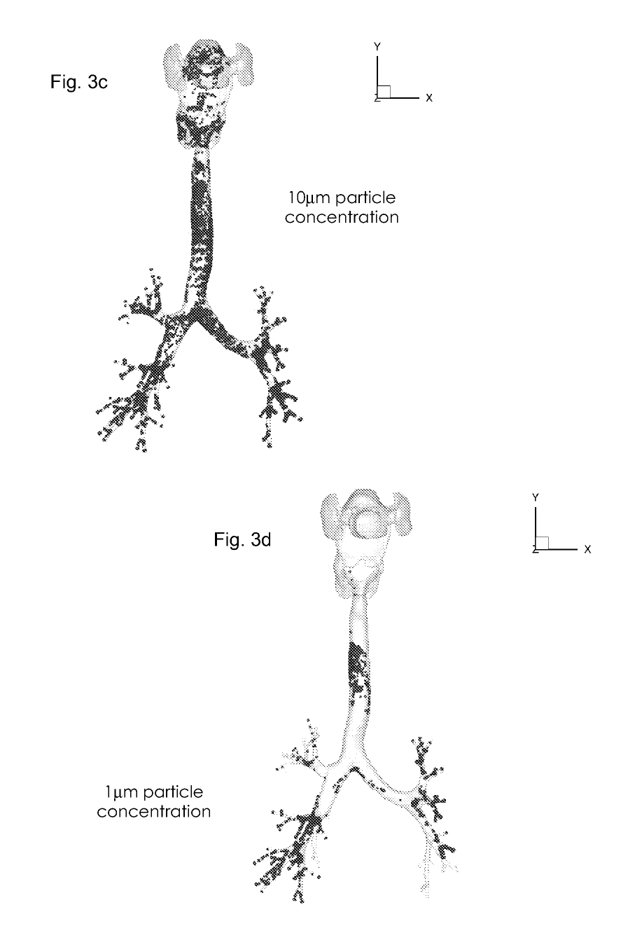

These volume elements have separate identities, managed in data memory by a programmed processor. Each volume element can have a uniquely encoded set of variables respecting location, orientation, size and also structural characteristics, such as elasticity. In addition to defining solid structures, volume elements bordering a solid structure can be encoded for dynamic conditions such as flow of air between opposite faces, pressure and the like. In FIG. 3, a set of volume elements 72, 73 are modeled for the opposite ends of a length of the modeled branching structure 60, and are construed to embody boundary conditions of pressure and flow through the modeled structure 60.

According to the model, the volume elements abut. Thus, the pressure and flow conditions are the same at abutting faces of adjacent abutting elements that share a face along a plane. Each element can contribute some incremental effect, analyzed by computational fluid dynamic techniques to infer the fluid flow characteristics of the modeled biological structure as a whole, by carrying the flow characteristics from one volumetric element to the adjacent abutting volumetric elements.

As shown in the two comparison views of FIGS. 3a and 3b, a particular set of boundary conditions may result—according to finite element computational fluid dynamic computations—in a turbulent area 75 associated with variations in the diameter and orientation of the flow path defined by the modeled passageway of the structure 60, shown in FIG. 3a. If one then changes the boundary conditions and recomputes as shown by FIG. 3b, a new result is obtained.

As discussed herein, boundary conditions are the values of parameters at predetermined locations in a structure, from which other parameter values can be calculated, including in some cases the values of the same parameters at other locations in the structure being modeled. Simulations of pressure, flow, transport, and/or deformation, in a structure of coupled tubular passageways, require definition of boundary conditions, for example, at each of the entrances and exits that affect pressure and flow conditions by admitting or exhausting flow. The boundary conditions can include externally coupled structures or effects as well, that affect deformation of the passageways in the model.

The boundary conditions define the conditions under which the model is operating, for example during positive pressure ventilation, or spontaneous breathing at a high flow rate. At the entry and exit locations of a set of coupled passageways, the boundary conditions may include pressure, flow, or an equation that relates pressure and/or flow to other variables. Boundary conditions may include, for example, an equation for a sinusoidal pressure or flow waveform at the mouth over time; or an equation that includes tissue elasticity and tissue tethering pressure computed from a model of soft tissue mechanics; or an equation that includes downstream flow resistance.

For branching structures that are tethered to some surrounding tissue (e.g. airways and blood vessels in the lung), further boundary conditions are defined to control the freedom or restriction of motion of the branch wall (its deformation). The instantaneous or time-varying defined pressure and flow conditions at the entrances and exits, the corresponding inflation and deflation of tissues that are defined spatially and by the elasticity or inelasticity of materials and any restriction of movement, are all pertinent conditions affecting the pressure and flow conditions in the modeled structures. The wall motion is computed starting from image registration, or using an equation that relates tethering pressure to wall motion. With respect to pressure and flow in a passageway or set of passageways coupled together, it is typically necessary to specify the pressure, flow and/or deformation characteristics at all entrances and exits to the passageway or set of passageways under consideration. Pressure and flow at other points are modeled according to cause and effect.

Similarly and as shown in the comparison views of FIGS. 3c and 3d, a given set of boundary conditions can include entrained particles in the air passing into and out of a lung in regular respiration. FIGS. 3c and 3d demonstrate a set of proximal branching generations from the trachea through about ten generations of branching. As described above, the pressure and flow characteristics of passageways that are more distal than those shown by this degree of modeling are inferred.

FIG. 3c shows the modeled result for one particle size, in particular particles with a 10 μm mean particle diameter. FIG. 3d shows a similarly modeled result for a smaller particle size, in this case for particles of 1 μm diameter. It is evident from a comparison of FIGS. 3c and 3d that while larger particles are deposited relatively uniformly on the surfaces of the larger branching passageways, the smaller particles are not uniformly deposited in these passages. It is an advantageous aspect of modeling as described herein, that although part of the model can be characterized for size and shape and structure in near anatomically accurate detail, the model also accounts for passages that are coupled in fluid communication with those shown. In the demonstration shown in FIGS. 3c and 3d, it can be inferred that a higher concentration of the 1 μm particles are deposited in the more distal passageways, namely the passageways that are modeled using the less extensive skeleton modeling discussed above, in fluid communication at the distal ends of the passageways shown.

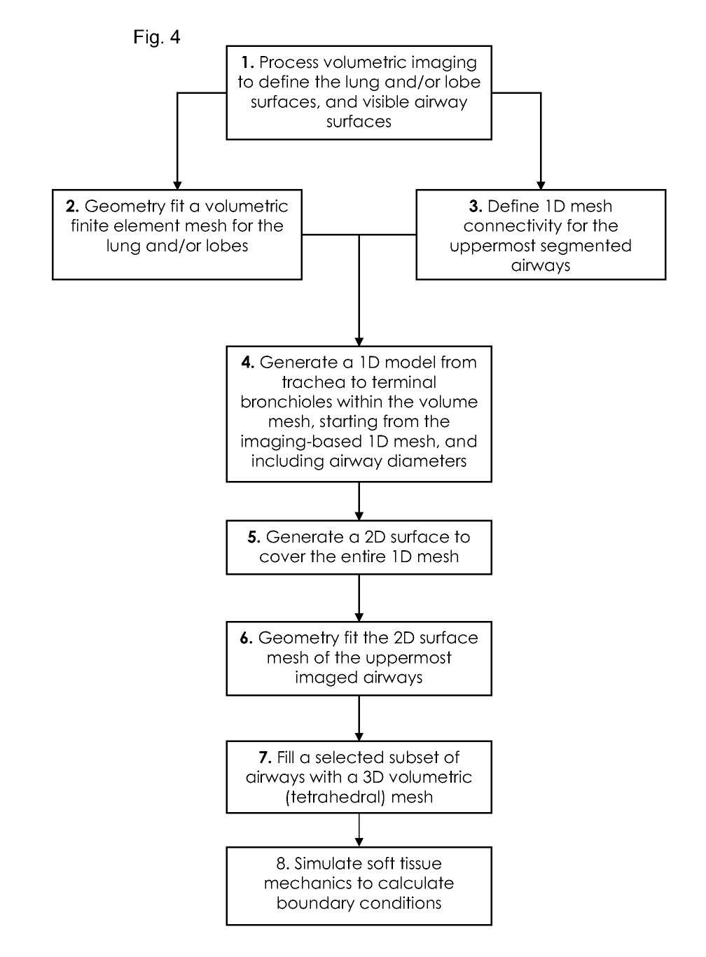

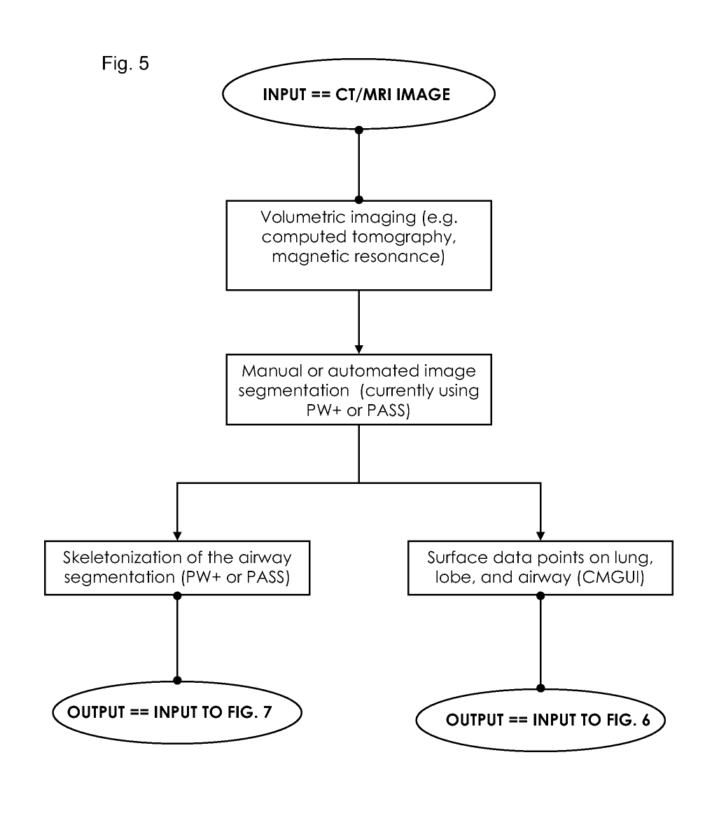

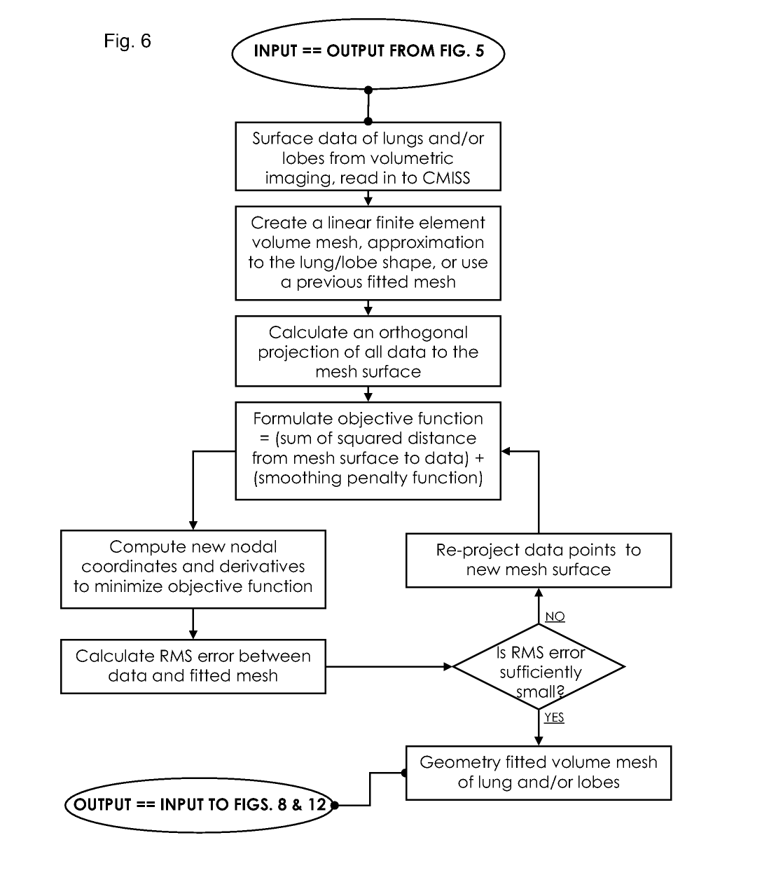

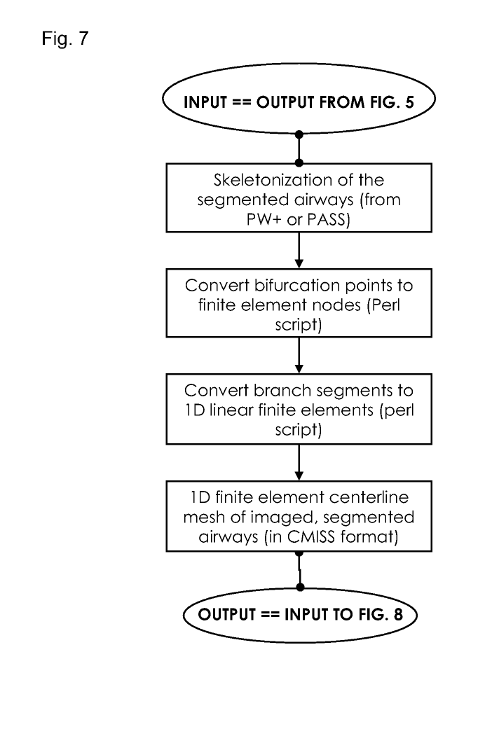

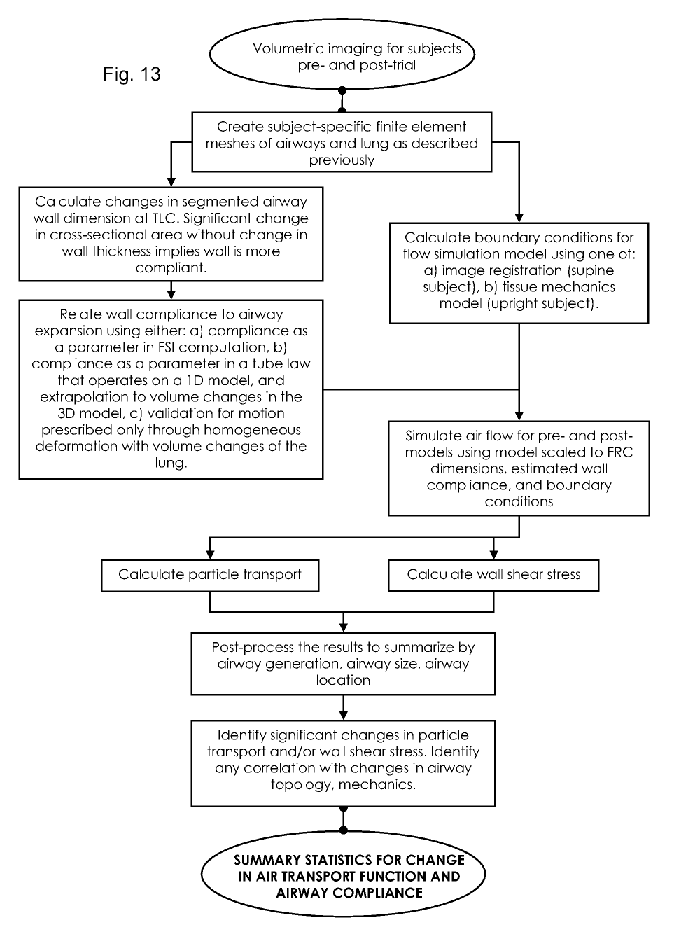

FIG. 4 is a summary and FIGS. 5 through 12 are details, demonstrating in flowchart form the steps taken to establish a biologically representative model, comprising representations and approximations embodied and stored in data memory, and to exploit the model. FIGS. 13 through 16 are flowcharts showing some exemplary applications.

In FIG. 4, the process begins with obtaining a volumetric image representing the lung and/or lobe external surfaces, and at least some visible airway surfaces. A volumetric finite element mesh is established to encode the external envelope (external surfaces as a whole). The mesh is geometrically fit to the external envelope of the lung and/or lobes (and or smaller volumetric structures) and thereby encodes by geometrical modeling the outer surfaces of the lung or lobe. For modeling, the biological structure (e.g., lung or lobe) is represented by data that individually identifies a plurality of volume elements of which the outer faces of adjacent volume elements at the outer surfaces represent the external envelope. In this way, an irregular shape can be accurately represented in the form of data. Surface matching a mesh can be accomplished by voxel data image processing or by providing two dimensional projections from different perspectives. Points on the surface are marked or noted and the data processor establishes a grid with surfaces that intersect the marked points.

In addition to encoding the external surfaces, the airways are defined. It is an aspect of the technique that the airways (or other branching structure passages) can be defined in different levels of structural detail, while retaining the capability to model the airflow characteristics of the airways or other passageways to a useful level of detail. One step is to define a one dimensional (1D) mesh comprising data representing simply a set of passageways and junctions at which the passageways are connected to one another at branches through which there is flow.

Preferably the passages and their connections are encoded for the uppermost segmented airways, namely those that are most proximal to a referenced proximal airway such as the trachea or a bronchus or bronchiole. The encoding is established by marking or measuring points at which branches are seen to occur in the volumetric image, carried from the proximal airway downwardly (toward more distal airways) in the branching structure. It is generally not possible to derive the positions of branches through a large number of generations. However, below a certain point (for example 10 generations in the human lung), the remaining structure of the branching passage is inferred based on nominal or average characteristics.

A 1D model is generated, for example from the trachea to terminal bronchioles at some number of branching generations, residing within the volume mesh defining the external envelope. The process starts from the image-based 1D mesh. Imaging cannot be used to set up the entire 1D mesh because of limitations in image resolution; it is possible to use imaging only to obtain true biological measurements for certain of the airways and to infer the measurement of other airways using nominal or average characteristics.

Among the measurements that are needed to define flow characteristics in the airways that are to be modeled based on measurements as opposed to inference, the airway diameters are measured and the diameter data encoded. A 2D surface is then established based on the 1D model plus the measured diameters. The 2D surface covers the entire 1D mesh for the airways to be modeled to this level of detail. The 2D surfaces can be modeled generally as cylinders.

A geometry fit matches the 2D surface mesh, at least for the uppermost airways in the image based model. Then these airways, or at least a selected subset of the airways is virtually filled with 3D volumetric elements defined in the data stored in memory. In one embodiment, the 3D volumetric elements are tetrahedrons. The volumetric elements fit in direct abutment and fill the volume. As a result, the outer surfaces of abutting volumetric elements define the surface of the mesh. The characteristics and conditions at the facing surfaces of abutting elements are equal. A finite element analysis can be undertaken wherein effects arising at one point in the branching structure, for example changes in pressure and flow conditions at a proximal location, can be analyzed as to the corresponding changes that occur elsewhere as a result.

The model is subject to more or less detail. Preferably the simulation in an area subject to analysis is done to as high a degree as needed to provide accurate results at the resolution of the particular study. For example, soft tissue mechanics preferably are modeled to modify or to establish boundary conditions. Thus, the dimensions of a passage can be affected by the balance of internal and external pressure leading to inflation. Other similar refinements are possible.

As shown in FIG. 5, exemplary techniques for obtaining the volumetric imaging data used in the first instance include computed tomography and magnetic resonance imaging. The image can be segmented (encoded as a series of airway lengths and their junctions) by manual or automated image segmentation techniques. Manual techniques can comprise manually selecting positions by point and click or crosshair or other position encoding techniques associated with a suitable interface for interpreting the user input as selected points in a three dimensional volume. Automatic routines for skeletonization of the airway segmentation (e.g., PW+ or PASS) can accomplish this task using pattern recognition to identify passageways and junctions. Similarly, the outer surfaces of the image are encoded by first selecting a representative set of points distributed on the external surfaces of the lung, lobe and/or airway (e.g., using CMGUI), to define surfaces for discerning 2D aspects such as thickness and curves and 3D aspects such as variations from cylindrical cross section, smoothed transitions, etc.

In FIG. 6, the surface data of the lungs and/or lobes from volumetric imaging and/or user input is read into CMISS. The surface data can comprise a linear finite element volume mesh fitted to include surface points, or an approximation of a nominal lung/lobe shape, or a previous fitted mesh for this or another subject may be available. Approximations or previous fittings can be adjusted as necessary. For fitting, an orthogonal projection is established in programming of the processor, with points as measured being noted, and points as approximated for the mesh to be fitted needing adjustment to match the measured points. A best fit solution for the mesh surface can be found by formulating an objective function representing distance. An exemplary distance measure is a sum of squares of displacement in each of the orthogonal directions. The best fit is the placement characterized by the least overall difference in positions of corresponding points. New nodal points, coordinates and derivatives can be computed to adjust the mesh surface to encompass the measured or noted points, and to minimize the objective function, e.g., the RMS difference in position. As shown in FIG. 6, this can be an iterative process, conducted until the RMS error is below some threshold of tolerance. The result is a geometry fitted volume encompassing mesh surface.

FIG. 7 details the steps associated with skeletonizing the segmented airway structures, for example starting with data defining the lengths and junctions of airway segments in the branching structure. In one embodiment, the bifurcation points (branches) are converted to finite element nodes and the airway branch segments are converted to 1D linear finite elements. This can be done in PERL script. The result is a 1D finite element mesh of centerlines and junctions corresponding to the imaged segmented airway branches. This information is stored in CMISS format.

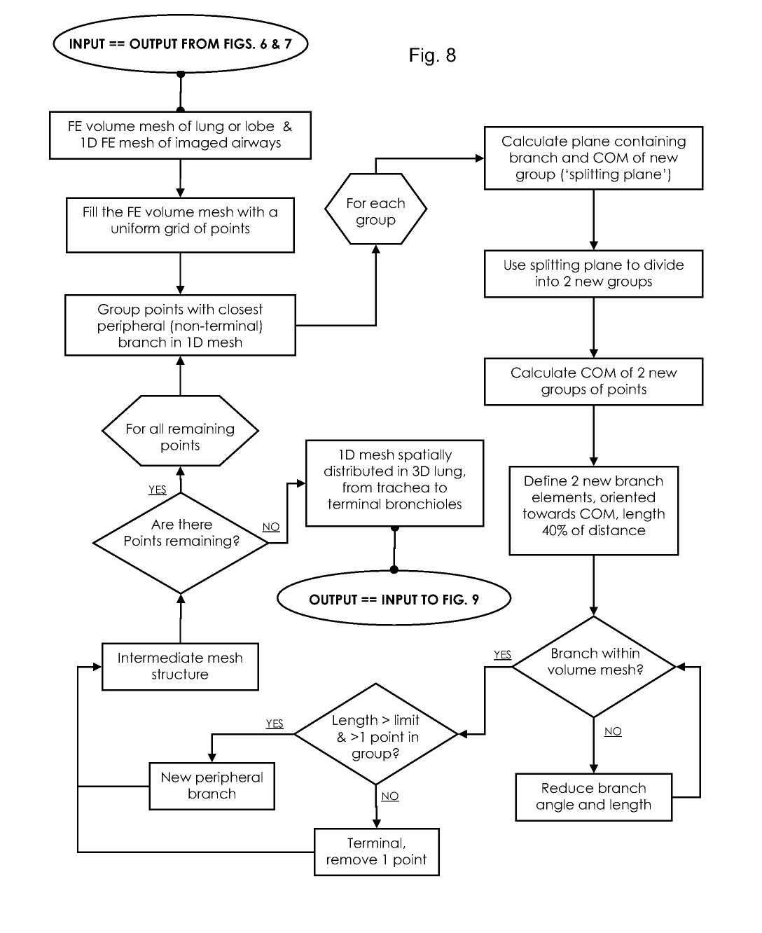

FIGS. 8-10 concern progressing from the 1D finite element mesh to curves, surfaces and volumes. In FIG. 8, beginning with a finite element mesh of the external surface of the lung or lobe and the 1D linear elements and nodes, the volume within the surface is filled with a uniform grid of reference points. The points are grouped with the closest peripheral (non-terminal) branch in the 1D mesh. Then for each group, a plane is identified containing the branch and the center of mass (COM), which shall be deemed a “splitting plane.” The splitting plane is used to divide the group into two new groups, each having a group of points and a center of mass. Between the centers of mass are newly defined segments (typically but not always shorter than the original 1D segment and oriented toward the center of mass), for example each with a length of 40% of the distance to the COM.

If a branch is thereby calculated that extends outwardly through the defined external surface, the branch angle and length are reduced until the calculated branch remains within the envelope. If the length of a calculated segment is greater than a minimum limit (one or more units), a peripheral branch is thereby defined. If the length is not greater than the limit or the group has only one point, the branch is defined as a terminal branch (up to the resolution of the mesh as calculated) and the point is eliminated. Continuing to define and fill the mesh, intermediate branch structures are defined in the same way for all remaining points. The final result is a 1D mesh that has been populated to fit within the 3D lung element from the most proximal passage, such as the trachea, to the bronchioles that define the resolution to which the model is carried. A further object will be to conduct fluid dynamics computations. Therefore, although the most distal modeled passages are described as terminal in this description of modeling, the terminal passages are deemed to branch further but are only modeled generally from that resolution downwardly.

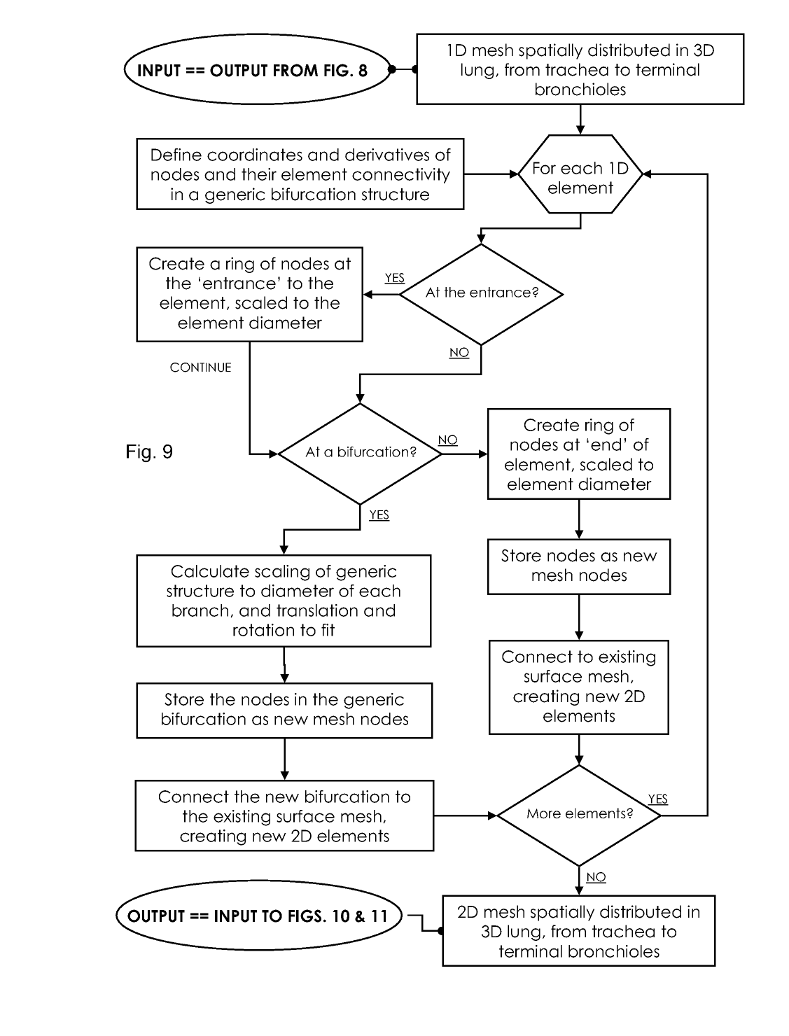

FIG. 9 shows the steps associated with further modeling the 1D mesh for shape and internal diameter. Up to this point, the mesh comprises spatially distributed lines and junctions in the 3D volume within the defined envelope of the lung or lobe. The nodes (branching junctions) and the derivatives or orientation of the passages between the nodes generally define a progressively bifurcating structure or branching arrangement wherein thicker proximal passages couple to thinner distal branches. This structure is to be defined in a manner that is useful to model the flow characteristics of the passages when proceeding with finite element computational fluid dynamic analysis.

For each 1D element or segment, a distinction is made if a 1D element is at the entrance to a segment, in which case a ring of nodes is defined. If the 1D element is not at the entrance, it may be at a bifurcation or at a continuation of a segment. If not at a bifurcation, a ring of nodes is defined as generally a lateral cross section through the passageway. The rings of nodes that are successively defined in this way have a changing diameter leading into the element from the entrance, generally reducing in diameter from the proximal to distal portions. The nodes are scaled to the element diameter, e.g. the internal and/or external diameter of the trachea, bronchus or bronchiole. The nodes are stored as new mesh nodes and are connected to the existing surface mesh.

If the 1D element is not at the entrance to a segment, the element may be at a bifurcation. For defining and smoothing a surface across a bifurcation or junction, the proximal and distal segments at the branch are approximated as generic structures, for example cylinders, each having a diameter scaled to account for the proximal segment being larger than the bifurcated segments distal to the junction. The surfaces of the generic shapes (e.g., cylinders) provide new mesh nodes for each bifurcation from a passageway as its diameter declines. The generic shapes are relatively translated and rotated to bring the structures into a fit. Connection of the mesh nodes are made across the transition. In this way, the 1D mesh skeleton distributed in the 3D lung envelope, e.g., from the trachea to terminal bronchioles at some number of generations of bifurcation, are encoded as a 2D mesh of surfaces with sizes and shapes, distributed in the 3D lung envelope from the trachea to said bronchioles.

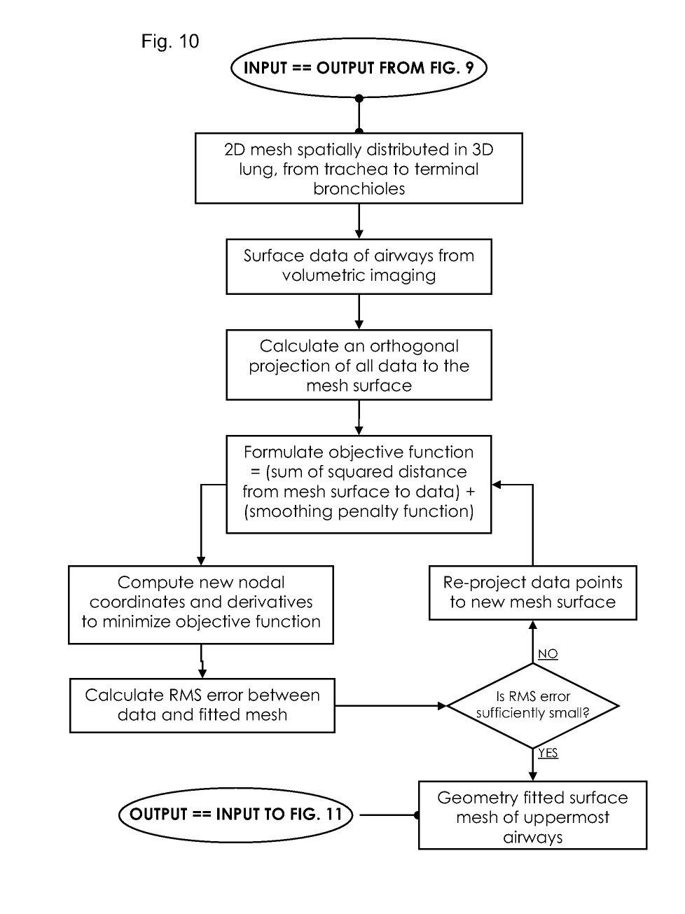

The flowchart of FIG. 10 continues from FIG. 9, showing the steps associated with making a geometric fit for the 2D surface mesh to the observed uppermost imaged airways. More particularly, the 2D mesh of modeled surfaces with sizes and shapes is to be matched to the observed biological structures to customize the model more closely to the patient. Data points for surfaces of the upper or more proximal airways are identified in the volumetric image. This can be an image processing step or a manual step wherein a set of points on the surface are identified by a user operating a user interface associated with a computer display. In either case, a representative set of points on the airway surfaces is marked and the locations of the points are stored.

An orthogonal projection is calculated, providing the coordinate reference system for the locations of the points. The coordinates for points on the surfaces in the computed model need to reflect the marked image points, namely by correlating the observed surface points with the modeled points. An objective function representing distance is employed. In one embodiment, the objective function calculates a sum of the squares of the displacements in each orthogonal coordinate axis and applies a smoothing penalty function. The coordinates of the nodal points on the model mesh and the derivatives or orientations of lines between nodes are then adjusted, for example moved toward a position at which the surfaces defined by the mesh intersect the observed point locations. The RMS error between the observed data point locations and surface planes of volumetric elements of the fitted mesh are calculated. If the RMS error remains more than a threshold of tolerance, the data points of the observed surface locations are re-projected, the objective function is re-calculated and the nodes of the model are repositioned again. The process incrementally adjusts the position, size and shape of the surfaces defined by the modeled mesh, displacing, swelling, shrinking or similarly shaping the surfaces of the modeled mesh to line up with the observed point locations and thus to fit the model geometrically to the upper air passageways as observed.

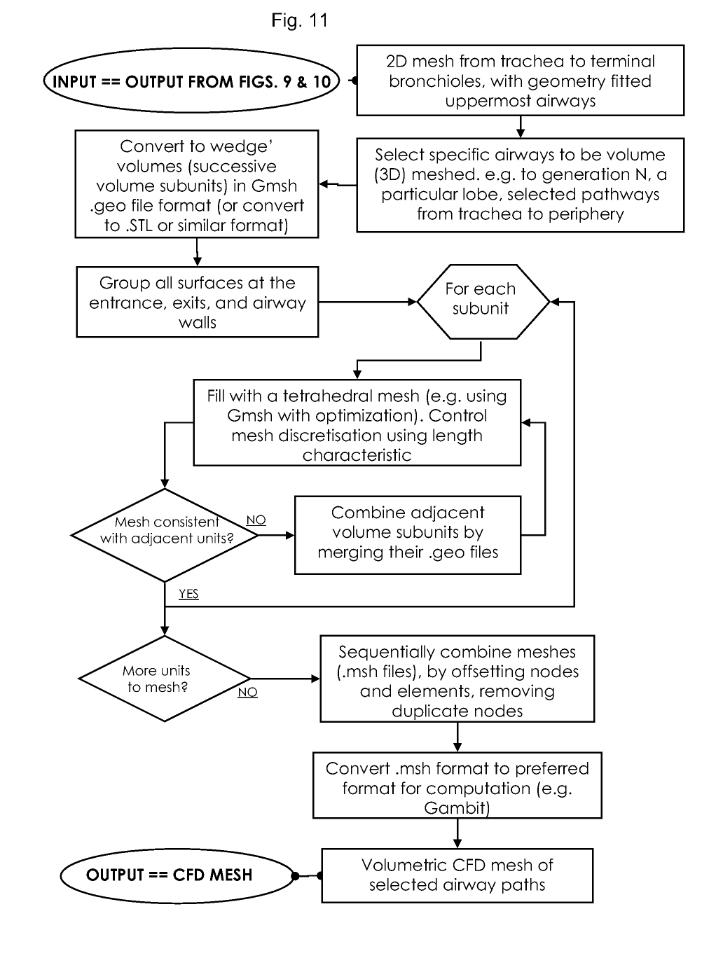

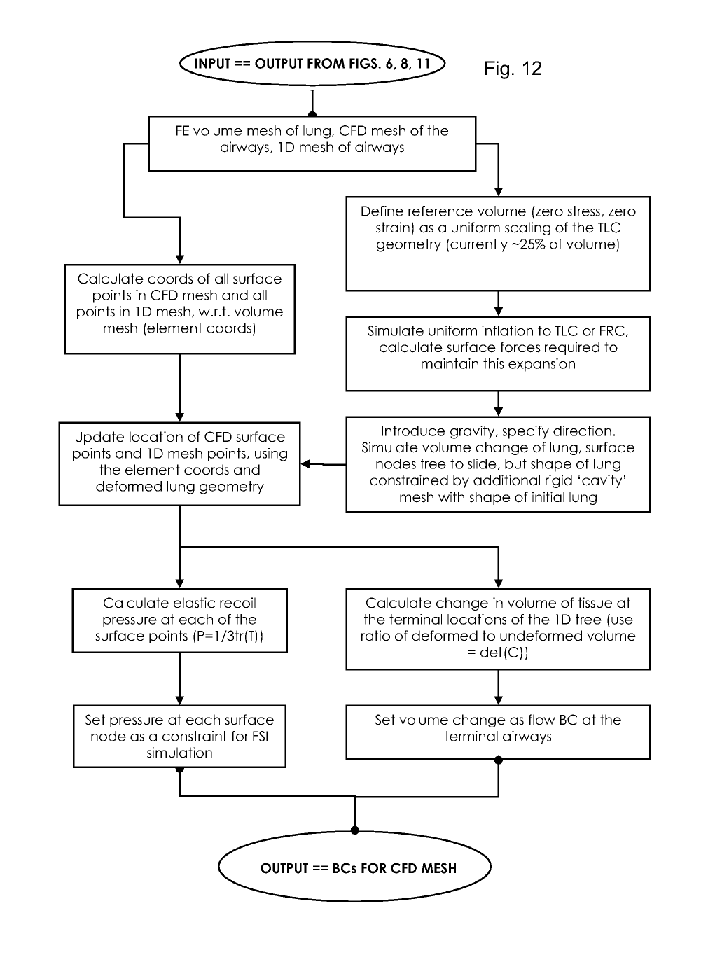

In FIG. 11, the adjusted modeled mesh is virtually filled or populated with virtual volume elements, by identifying a full set of volume elements, defined by sizes and locations stored in the data processing memory. This process provides a 3D volumetric mesh wherein the surfaces of the biological structure, including for example the inner surfaces of the airways, correspond to surfaces of the volumetric elements. In addition, the volume is filled with virtually defined volume elements that are stacked and abutted in virtual modeled space. For computational efficiency, the 3D filling preferably is accomplished for a selected subset of the airways, namely a subset that is under scrutiny. The subset can be selected as a volume between coordinates in model space, or as a particular number of branching generations above and/or below an identified airway segment, or as a discrete lobe, or along selected pathways, for example, from the trachea to the periphery.

In one example, passageways that are initially deemed to be cylindrical are divided for processing into four wedge shaped volumes radiating from the cylindrical centerline to the cylindrical wall. The wedge shaped subdomains can be processed separately into smaller volume elements, or considered in groups of adjacent volume units to define a larger scale volume unit. The volume units each have an identity in the programming and digital memory of the system, and can be defined and stored in the Gmsh .geo file format or converted to .stl file format. (See http://www.geuz.org/gmsh/.) Volume elements whose surfaces correspond to all the entrance and exit planes and airway walls are associated with one another when considering pressure and flow conditions, restrictions on flow directions and the like.

For each subunit of volume, a tetrahedral unit mesh is filled, e.g., using Gmsh with optimization. Using very small volumetric elements, the mesh can be made to closely approximate smooth curves, but more computational complexity is introduced by having more separately defined elements with locations, surfaces, orientations, etc. Preferably, the extent of discretization into smaller and smaller units is limited by a length characteristic. For some purposes, it may be desirable to select a longer characteristic to reduce computational complexity at the expense of defining surfaces more coarsely. For other purposes, a shorter characteristic may be desirable for computations that are finely matched to modeled surfaces and shapes. In a given solution, it is possible to have different areas or structures modeled to different degrees of fine and coarse modeling.

Virtual filling of a volume subunit with defined volumetric elements is an iterative process because the volumetric elements of adjacent volume subunits are to have common surfaces. After defining a volume mesh of tetrahedral units, if the surfaces of the defined mesh do not align with those of an adjacent subunit, the .geo files of the subunits can be merged in Gmsh and their combined volume filled virtually with volumetric elements. If the surfaces do align, the two subunits can retain their separate identities and be handled in that way during further operations.

When all the necessary units are defined as meshes of volumetric elements, the meshes for the units (.msh files) are adjusted for processing as one system, e.g., by offsetting the mesh nodes and element, by removing duplicate nodes and generally attending to transitions from one of the units to another. It is useful at this point to convert the .msh file format to a format that is preferred for fluid dynamic computations, such as Gambit. The point is to exploit the defined volumetric mesh by testing mathematically how selected conditions at selected places in the lung or other branching structure affect conditions elsewhere.

Referring to FIG. 12, finite element fluid dynamic computations can be carried out using the defined volume elements. Moreover, the computations can be extended from the airways that are 3D volume meshed, by taking into account conditions in other airways that are associated with the airways that are 3D volume meshed. In such other airway, the 1D mesh can be modeled according to nominal or average values of pressure and flow, for example, or constrained by interaction with image registration or soft tissue mechanics to prescribe a volume change in the distal tissue subtending the 1D mesh. However, at the 3D volume meshed zone, conditions can be modeled and examined in more detail, such as to model local turbulence, to assess local deposition of particulates, etc.

For these purposes, starting with a set of finite elements comprising the volumetric 3D mesh volumes between nodes and planes as defined above, for a subset of the airways, and a 1D mesh information for the remainder, a computational fluid dynamic mesh is defined. For the 3D mesh, conditions at common planes are equal. Differences in pressure lead to air flow. The flow is constrained by the shape of the airways. The shape of the airways can change during respiration. At the junctions between more and less extensive modeling, for example where the 3D mesh modeling ends and 1D modeling begins, nominal boundary conditions are assumed. Depending on the sophistication required of the computational fluid dynamic test, the boundary conditions can assume simple laminar flow and static pressure, or a slip stream with flow concentrated centrally and changing pressure, etc.

In FIG. 12, the coordinates of all surface points to be regarded as parts of the computational fluid dynamic mesh are determined and stored. Likewise, 1D mesh elements leading to or from the associated 3D volume are provided in programming. A reference volume is assumed, with no applied stresses or strains. For example, the reference volume can be a percentage of total lung capacity (TLC), such as about 25% of maximum geometrically possible volume. Uniform inflation is assumed up to total lung capacity or up to a functional residual capacity (FRC, the volume of lung after passive expiration). The surface forces required to maintain this expansion are determined, taking into account the elastic capacity of the soft tissues being modeled.

Preferably, further factors are taken into account. These can include, without limitation, gravity together with lung and body orientation. The volume changes of the lung can be constrained, e.g., to account for action of the diaphragm, by simulation that permits surface nodes to slide but enforces the shape of the lung by modeling for the shape of the cavity in which the lung resides. More or less rigid cavity elements such as ribs can be added to the model as an additional mesh of constraining elements, with the initial shape of the at-rest lung.

In connection with changes in pressure, flow, orientation, respiration, and the like, the location the modeled points of the computational fluid dynamic surfaces and the effects of the 1D mesh elements are updated. That is, the coordinates of the elements are repetitively adjusted to account for inflation, deflation and deformation of the lung geometry with force. The tethering pressure exerted at points on the defined surfaces is calculated. The pressure at each surface node is determined. The effects of changes in volume of the tissues are calculated, including for the transition locations between the 3D and 1D models and including terminal locations. For the 1D model, the calculations can be relatively simplified, for example by repetitively calculating the ratio of the deformed to undeformed volumes at the 3D modeled volume, and using that ratio as a factor to infer changes in the volume of the tissue subtending the 1D modeled airways. It can be assumed that the 1D nominal volume is changing according to a similar ratio. The volumes of air leading into and out of the 1D modeled airways provide terminal air flow conditions that interact with the 3D modeled airways, and their difference is a matter of inflation and deflation during respiration.

The foregoing model is useful for various informational, diagnostic and therapeutic applications. Referring to FIG. 13, one application is to compare “before” and “after” conditions of the airways when one or more airways is subjected to change, or perhaps the biological subject as whole is subjected to some event. The event might be a pharmacological dosing, installation of a prosthetic device, exercise, surgery, healing over a passage of time, or any other event that may change the lung or lung functioning. The technique is therefore run before and after the event and comparisons are made.

Therefore, and as charted in FIG. 13, subject-specific finite element airway and lung envelope meshes are prepared and stored in data memory. In addition to modeling for airway volumes using the meshes, static and dynamic measurements can be collected, for example to assess lung function using external test equipment, optionally with exercise and associated cardiovascular testing.

Among other preliminary measurements, a useful measure is the change in the airway diameter with expansion of volume. The relationship of the change in cross-sectional area of the airway versus the change in expanding pressure can be a measure of the extent to which the wall is compliant. The compliance of the wall is related to airway expansion using one or more of compliance as a parameter in FSI computation, compliance as a parameter in a tube-law calculation (for example on airways that are limited to the 1D model with extrapolation to the 3D modeled airways), and/or validation for motion prescribed only through homogeneous deformation with lung volume change.

For repeatable before-and-after comparison tests, the boundary conditions and general test conditions need to be established and repeated. The boundary conditions for the flow simulation model can be associated with image registration (with the before-and-after subject supine) or with tissue mechanics (with the subject supine, prone, upright, inverted). Air flow conditions are simulated for the pre- and post-event models. In each case, the models should be referenced to the functional residual capacity (FRC) values used in the pre-event test (which enables more direct comparison of data than establishing a new FRC for the subject post-event. Wall compliance values and boundary condition data are collected both before and after the event.

Among other variables, particle transport aspects can be calculated and compared. Wall shear stress and flow resistance values are calculated. The results of modeling post-event are assessed. The results can be summarized with respect to airway generation, size and location. Significant changes in particle transport and/or wall shear stress and/or flow resistance should be identified. Any noted correlation of such changes with changes in airway topology or mechanics can be studied and made the subject of further diagnostic and therapeutic activities.

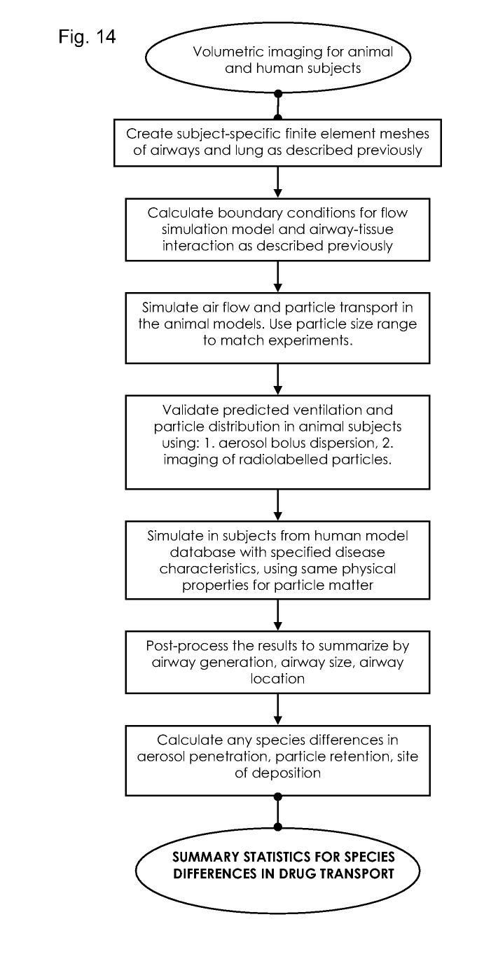

An application related to comparing before and after conditions is shown in FIG. 14, which concerns comparing conditions for two different subjects. In this case, the subjects need not be the same species, for example in the case of using animal subjects for conducting tests, the results of which tests are inferred to be relevant to humans. By modeling both human and animal subjects, it is possible to make comparisons based on similarities and differences.

Initially, subject-specific finite element meshes of airways and lung are made as described above. The boundary conditions for simulation of flow are set and measurements are taken for compliance and other parameters that characterize interaction of the airway tissues with changes in inflation. Next, air flow and particle transport simulations are run using fluid dynamic computational techniques, on the animal subject. These simulations should include particles with a size and other characteristics equal to those of a test composition such as a particulate pharmacological substance. The test composition then is applied to the animal subject in an experiment. A comparison of the actual and predicted deposition characteristics of the particle can be made to validate the predicted results of the model. Predicted ventilation and particle distribution results can be validated in the animal subjects using an aerosol bolus dispersion and imaging of radio-labeled particles. The model can be adjusted if necessary.

Subsequently, similar modeling is carried out on the computational fluid dynamic model associated with a human subject, or perhaps a nominal model referenced to a class of human subjects, or to humans having a given disease condition. For one human subject, or better yet for a statistically significant group, the model is run in the before-and-after event sequence discussed, namely before and after administering the pharmacological substance. The post-event modeling results for airway generation, airway size, airway location, compliance, particle deposition, etc. are noted. Insofar as species differences in aerosol penetration, particle retention, site of deposition and the like are seen to occur, they can be investigated. Where it appears that there is a strong correlation of cross-species results, or a strong correlation of results subject to an adjustment to the animal modeled data, further testing of the animal model and animal subjects have been seen to relate.

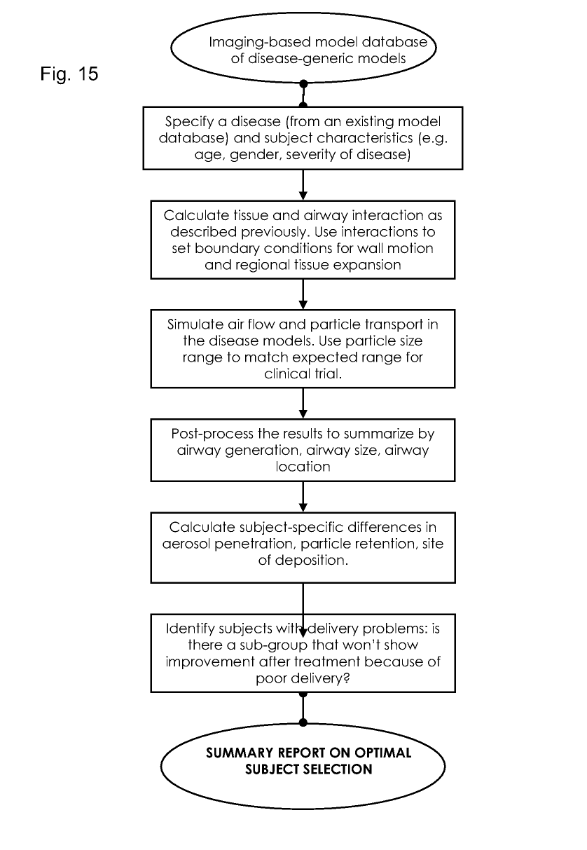

In another application, shown in flowchart form in FIG. 15, the model can be exploited to assess whether particular subjects are appropriate for a procedure based on modeling plus the benefit of models run on other subjects who were similarly disposed. For example, a model database is accumulated wherein the database includes model data plus information on diseases, and optionally information on additional subject characteristics, e.g., age, gender, medical history, demographics, severity of disease, etc. Tissue and airway interactions are calculated as described above. The interactions are used to set boundary conditions for wall motion and regional tissue expansion. By operation of the models of diseased subjects, air flow and particle transport conditions are simulated using a particle size range that is to match an expected range for a clinical trial of a particulate composition. The results are post processed, and summarized by airway generation, airway size, airway location, and subject-specific differences are determined as to aerosol penetration, particle retention, site of deposition and similar factors. This technique is useful to discriminate between subjects that may or may not have certain composition delivery problems. This may help to identify a sub-group that won't show improvement after treatment with the composition because of poor delivery, and possibly suggest that alternatives should be sought.

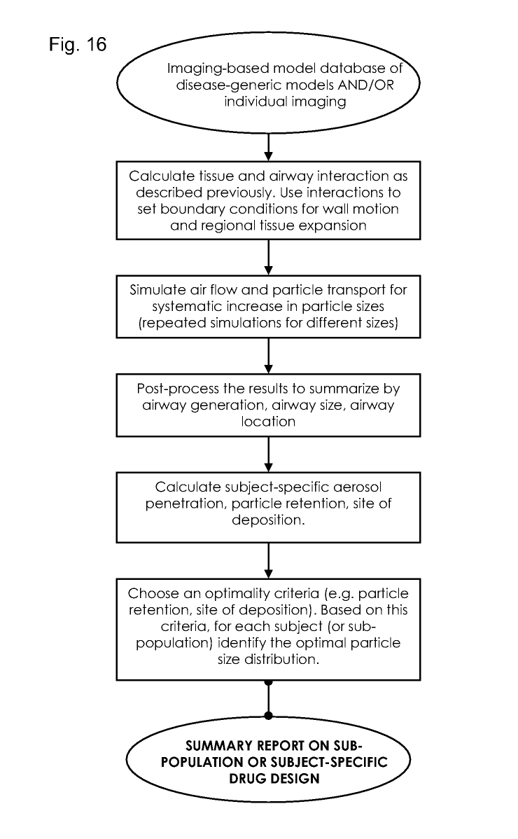

FIG. 16 demonstrates a further application, in this case for tailoring the design or dosing regimen of a drug to an individual or to a subset of the population having distinct characteristics. Data is collected to provide an imaging-based model database of disease-generic models, or individual imaging data is collected, or preferably both. Tissue and airway interactions are calculated as described previously. The interactions define boundary conditions concerning wall motion and regional tissue expansion. The model is used in a computational fluid dynamic analysis to simulate air flow characteristics. Particle transport and deposition parameters are modeled, over a systematic distribution of particle sizes. That is, the simulations are repeated for different sizes and a set of results are obtained for each of the particle sizes modeled. These results are processed to summaries particle distribution results according to airway generation, airway size, airway location and other factors.

For the individual subject, specific aerosol penetration, particle retention, and site of deposition information can be obtained from the model and the particle size. For all individuals who meet the characteristics of a population that is unique with respect to the aspects that are input into the model, it can be inferred that the subjects will experience similar results as to aerosol penetration and particle retention. The site of deposition may vary as the structural characteristics of airways vary, but for similarly structured airways, the subjects in a unique population also are expected to get similar results. One or more criteria are established to determine optimal results (which might be particle retention, site of deposition or another factor for different particulate compositions), and based on this criteria an optimal particle size distribution is specified for the subject (or for members of the unique population).

The foregoing application is useful for managing the design of particulate and aerosol compositions to be delivered into the lungs. By carrying out testing by simulation in silico, namely by programmed simulations in a data processor, useful information is obtained for proving designs and for matching designs with patients. Due to the fact that part of the simulation is based on measurements and part is based on modeling, a less time consuming but still representative mesh model is provided for complex branching structures such as airways. The capability of modeling part of the airway structure in 3D detail and another part in 1D or 2D skeleton form reduces computational load. The 1D/2D and 3D modeled portions of the flow paths are handled in the same simulation at the same time by employing normalized parameters as the conditions for the 1D passage models at the point of transition into detailed 3D modeling.

Models of the entire airway tree are thus created, wherein only selected pathways through the tree, or only pathways between a selected number of branching generations are meshed very finely for computational fluid dynamic analysis. Yet the entire tree is represented in the model.

The system can be operated with the benefit of automation using an imaging system capable of producing volumetric image data, and a programmed processor running image analysis routines or accepting user-located points on orthogonally projected 3D images. The technique is apt for collecting extensive information in a database of subject characteristics and computational fluid dynamic analyses by which results of analysis for a subject in a subset of the population is made useful for other members of the subset.

As a result, the testing and modeling is applicable to drug development, design of delivery systems, effectiveness testing for regulatory approval, and matching of therapies, dosages and pharma composition characteristics to patients. The technique is described primarily with respect to the deposition of particulates but does not exclude aerosols. In addition to studying physical movement of drugs to bronchial locations, the technique is applicable to the study of drug absorption parameters including transfer of compositions or components of compositions into the pulmonary circulation. The same techniques can be used to study the clearance of materials via mucociliary transport.

The disclosed modeling supports the design and deployment of devices the may assist in procedures and therapies. Endobronchial valve technology, for example, is coming into use as an alternative to lung volume reduction surgery. Modeling methods as disclosed can help to arrive at an optimal valve size and location for placement, eliminating trial and error or guesswork. The effects of external ventilatory support devices are subject to modeling and control for limiting airway wall shear stress and controlling or eliminating associated inflammation. Respiration can be modeled under unusual conditions, such as those of military pilots subjected to high G forces or divers in pressurized suits or spaces.

The disclosed technique is applicable to various studies, simulations, plans and similar activities that benefit from the ability to estimate and infer the operational characteristics of the lung or other branching organ, especially when testing for the results of different planned activities such as therapeutic steps. As an example, lung resection surgery (namely surgery to remove a portion of the lung tissue) has been used in the past to treat patients with emphysema. It has been believed that removing the tissue that is most compliant/emphysematic may improve overall lung function. Surgical removal of tissue may not be preferred for this patient group in the future if endobronchial valves or similar devices prove successful to isolate such tissue. The treatment will still be necessary for patients with operable lung cancer.

One difficulty is that a cancer patient may have some loss of lung tissue elasticity, possibly associated with emphysema or possibly due to normal aging processes, or both. Removing lung tissue can be expected to reduce lung function. Removal of a substantial or unnecessary amount of functioning lung tissue along with a tumor might lead to a serious decline in lung function. What is needed is a tool for predicting the lung function outcome for these patients, particularly to assess surgical or therapeutic alternatives and to make appropriate risk/benefit analyses based on reasoned projections as opposed to guesswork.

Accordingly, the model as discussed can be applied to predict the effects on lung function of different alternatives. In the case of a lung resection, estimates of a patient's regional lung elasticity are made from image registration data. The model can project or predict what would happen to the patient's lung function as a consequence of a particular surgery or enable a comparison of alternatives. In that event, the technique comprises imaging, calculation of regional tissue elasticity derived from the imaging, application of the lung and airway models—including 3D CFD and/or 1D pressure-flow—and their interaction with tissue mechanics. Advantageous outputs of the modeling include calculations of redistribution of tissue stress and strain, stretch experienced by airways, ventilation distribution, gas exchange, changes to distribution of particles (sensitivity to pollutants and/or assessment of drug therapies) due to boundary conditions (including said tissue expansion) and airway geometry.

The system can be embodied as a software package sold as a unit for operation on general purpose computers at a hospital or doctor's office. The software package can use extensively customized modeling based on CT imaging supplied to the practitioner for analysis. In a less capable embodiment, the system alternatively can be configured to calculate outputs based on low cost modeling using nominal assumptions as to branching passage way structures and lung mechanics, including inferring passageway characteristics using the 1D airway modeling as discussed above. In another embodiment, the technique can be embodied as a communications-based service over the worldwide web or otherwise, wherein imaging data is collected from the client by a testing facility and uploaded (for example by a hospital board or private surgical practice). The data and potentially hypothetical surgical proposals are proposed. A summary report is then produced by practitioners who are experts at running the simulations and analyzing the output with respect to characteristics that inform the patient and his or her surgeons.

According to further detail, CT imaging data is uploaded to characterize the lung at total lung capacity (TLC) and functional residual capacity (FRC), preferably in association with clinical measurements that are made, for example including lung volumes and capacities, blood gases, DLCO. The upload can be responsive to prompting from a software package or a web-based service.

The lung, lobes, and airways then are virtually segmented by an automatic or human-assisted programmed operation. A finite element volume mesh is defined in memory and fitted for the lung or lobes. A centerline (1D) mesh is traced for the CT-segmented airways and extended automatically into the lobe volumes comprising the total lung capacity (TLC) at issue. Sample paths can be selected for fine-scale (CFD) meshing. Coordinate transformation from TLC to FRC is calculated by registering the images at the two volumes. Tissue compliance at any point in the lung volume is proportional to the Jacobian of the coordinate transformation (the change in volume).

The compliance of the tissue that is distal to the outermost modeled point on the branching structure is also modeled, but by inference. The tissue beyond each terminal point on the bronchiole in the branching is calculated as the average of the compliances of all voxels in an acinus-sized volume. The magnitude and time variation of the pleural pressure change is specified to simulate breathing. Atmospheric pressure is set by default at the mouth (or other conditions can be set if desired). The airways and tissue interact during simulation, (1.) at the interface between terminal bronchiole and parenchymal tissue by equations that balance tissue tethering force (calculated from 3D soft tissue mechanics), alveolar pressure, and tissue volume change; and (2.) at the interface between airway wall and parenchyma by fluid-structure interaction (3D) and a tube law (1D), each of which depends on the local tethering force exerted by the tissue (from 3D soft tissue mechanics). Ventilation distribution is simulated for the baseline (pre-operative) lung. From this simulation it is possible to calculate respiratory gas exchange, particle transport, and the inhaled drug deposition efficiency data.

In order to simulate post-operative conditions, the user specifies the section of lung tissue that is proposed to be removed. This section is then removed from the lobe volumetric model and from the airway model. The model is adjusted to accommodate the surgical removal, for example, the remaining lung tissue is assumed to expand to fill the pleural cavity. The effect of this change on lung function is simulated by calculating the tissue forces (and therefore tethering forces) that result from this change in lung geometry, and re-simulating ventilation distribution, gas exchange, and particle transport for the new conditions, including the missing contribution of the removed section. Pertinent output data from the analysis can include changes in: gas exchange, drug deposition efficiency, and regional tissue stress.

An application of the present techniques using the 1D tree and tissue mechanics models, which application need not also include the computing of flow, is the planning of radiation therapy. Radiation therapy to target lung tumors is complicated by motion of the lung and tumor during breathing. The present model can compute tissue motion and tumor, airway, and blood vessel displacement during breathing or deep inhalation.

The model and simulation are embodied in a software package. The operator inputs CT and MR imaging for a patient, where the CT imaging is a static volumetric scan taken at total lung capacity, and the MRI is retrospectively gated from imaging during spontaneous (tidal) breathing. The lungs, lobes, airways, tumors, and blood vessels are automatically segmented from the CT imaging, and a volumetric finite element model of the lungs and/or lobes is fitted. A model of each of the airways, arteries, and veins is created to match the branch centerlines of the segmented imaging, and extended into the rest of the lung using the volume-filling method.

A grid of points that fills the tumor location is calculated with respect to the coordinate system of the lung volume mesh. The surfaces of the two lungs are segmented from the MRI, for each sampled time interval during several spontaneous breaths. The time interval displacement of the inner chest wall (the surface adjacent to the lung) is defined to match the displacement measured from the MR imaging. Deformation of the lung model from total lung capacity to functional residual capacity is calculated using finite deformation (large strain) theory for a compressible tissue. Spontaneous breathing is simulated by displacing the inner chest wall in accordance with measurements from MRI in a step-wise fashion.

Following each step displacement a new lung model deformation is computed. The boundary conditions for the step-wise lung deformation are a gravitational vector and enforcement of frictionless (sliding) contact with the inner chest wall. The step-wise location of the tumor and each airway or vessel is computed by assuming that the structures move with the tissue, therefore their location with respect to the lung volume mesh do not change.

The output of the method is a visualization of the tumor and tree structure displacement during breathing maneuvers. The 3D displacement of the tumor during breathing is quantified. The direction and timing of radiation can be optimized to minimize damage to tissue surrounding the tumor or to major airways and blood vessels.

The subject technique is not limited to applications that involve pathology, surgery and tissues that may have lost function due to age or disease. For example, many cities and other state entities have restrictions (or at least guidelines) on the acceptable level of particulate matter and/or gaseous pollutants allowable in the environment. Guidelines are set based on estimates of levels of pollution acceptable to an average human. This does not take into account the increased sensitivity of susceptible individuals: those with lung or cardiac disease, the elderly, children.

Operation of the modeling technique to determine the sensitivity of at-risk groups can be used to assess and fine tune, and perhaps to lead to new requirements for urban restrictions and guidelines. For example, limitations can be placed on traffic volume in areas near hospitals or schools. Pollution levels can be monitored with sensors placed in strategic locations. While this provides information about pollution and its spatio-temporal variation, it does not describe what happens to the individual.

The subject modeling technique, as a predictive model, can be integrated into an urban design package, for recommending zoning that will suitably separate particulate sources from sensitive persons. The modeling technique can be applied as the tool of a bureau service for evaluating population risk. In one example, a database of in silico subjects is defined, preferably by collecting model data from a statistical sample of population subsets, from CT imaging. Particle and gas inhalation are simulated for specific groups. The groups can be defined as a ‘typical’ asthmatic, for example, the average characteristics of asthmatics according to a statistical sampling. Alternatively, data can be collected for every asthmatic in a treatment history database to define an appropriate population subset. In the case of a ‘typical’ subject, an object may be to minimize computation time. If so, a lower cost model may be applied (e.g., using only 1D modeled airways and tissue mechanics). In the case of actual data from a treatment history database, high accuracy solutions may be appropriate, valid and useful for making inter-subject comparisons. The beneficiary in this type of application is the general public. The client may be, for example, a local government entity, a transportation authority, urban or suburban planning commissions, zoning boards and similar entities.

According to one example, a database is generated of in silico subjects that includes records that model each of their lungs and airway trees. The models can be taken to more or less degrees of detail, but preferably are sufficient in detail and number to encompass and characterize a normal variation in lung topology that is representative of the general population or a defined subject group or subset. Parametric information is collected to associate the model data with different subject groups, so that when convenient it is possible to select records involving a subset. For example, lung volumes, airway sizes, tissue and chest wall elasticity data might be collected as a function of developmental status, i.e., children as opposed to adults. A correlation can be established or made possible by collection of sufficient data to cross reference lung volumes and conditions such as asthma or emphysema, gender, ethnicity, age, preferably including information on the sample size and variance sufficient to assess statistical probabilities. In general, subsets of a population can be distinguished as a function of physical structure, demographics, age, conditioning, disease conditions and similar factors that may cause aspects of the structure of the branching passageways or aspects of the boundary conditions to vary from one subset to another.

The operator selects the subject group of interest (such as moderate asthmatic adults, for example). Selection may also be possible with respect to height or age or the like, depending on the samples that have been stored in memory or otherwise made available. The starting point is an ‘average’ lung topology for simulation of such a subject. This data is then modified to simulate the example of a moderate asthmatic, for example by adjusting the data for virtually stiffening the airways (operator specified). This has the effect of reducing the FRC airway size for application of the model, and the expansion of the airways during breathing. Other specifications for the individual can also be accommodated, such as specifying any existing impairment of the lung tissue.

Ventilation distribution, and noxious gas and particle transport/deposition/uptake can be determined by running the model for environmental conditions that are specified by the operator (such as concentrations of particulate or vapor pollutants, particular temperature and/or humidity conditions, etc.). Preferably, the operator in connection with modeling for a subject group has the option to set a range of variation that they want to simulate (for example, male and female; child and elderly). The simulation can be repeated for each of these groups or reported as ranges of output variables corresponding to the variations of model characteristics. Preferably, the operator also has the option to model for different degrees of physical exertion, for example to determine the difference in response of a pedestrian (normal ventilation) versus a cyclist or runner (elevated ventilation). The final output is a summary of pollution deposition and uptake for a ‘normal’ lung, and for the subject groups that have been studied and are represented in the database by their representative model characteristics. It is likewise possible when modeling for an individual to incorporate expectations of performance in different states of physical exertion and/or to model for different pollutants or gases in a similar manner.

The disclosed techniques can be supported by programming embodied in code executable on general purpose computers. An important aspect is use of a 1D centerline model for the airway tree, based on both imaging data and a mathematically generated model of a nominal distribution of airways. The 1D portion encompasses and represents much of the lung as an array of idealized airways. In at least a portion of interest such as the proximal airways, a 3D fine-scale tetrahedral meshing is built onto the 1D skeleton and the skeleton is adjusted based on the location of points noted on the surface of the subject's imaged lung or other organ, to conform the model to real life in the area. The application of physiological boundary conditions to the 3D mesh enable computational fluid dynamic processing and facilitate post-processing of numerical results.

The disclosed technique includes a process of volume-filling a space equal to the imaged volume of a lung or similar organ, with a virtual passageway tree. The volume-filling tree has a geometry that is consistent with published morphometry of the airways but below (and optionally above) the 3D meshed zone, the passageways are idealized. An xml-based description of a tree skeleton that is derived from custom segmentation of an individual's lung images can be used to describe the centerline and diameters of the uppermost airways. Diameters for the generated airways are assigned such that they merge seamlessly with the imaging-based airways. Each 1D (line) branch and its associated diameter are converted to a mathematical description of the surface geometry, by initially assuming that the airways are smooth cylinders.

The mathematical description of the airway tree from the uppermost airway to the terminal bronchioles is therefore consistent. Then, the uppermost airway geometry is modified to accurately represent the subject's anatomy using geometry fitting to imaging data. The initially cylindrical surface mesh data represents points on the surface of the airway tree (listed in the xml tree file). Geometry fitting includes displacing, smoothing and shaping to fit the imaged surface data points.

Sequential computational fluid dynamic meshing starts by dividing the airways into sub-domains. The 1D mesh (imaged and generated) is used as a central scaffold to divide the airway volume into four radial wedges or cylindrical quadrants that extend axially along the sharp central point or edge of the wedge. Each wedge is a mathematical description of a small unique volume. A tetrahedral CFD-appropriate mesh is generated within the wedge. It is possible to employ a system such as the open source gmsh meshing software (www.geuz.org/gmsh) when defining and manipulating the volume elements.

The distribution of air and particles is determined by airway geometry and the pressure gradient. Different regions of the lung develop different pressures during inspiration and expiration, depending on location, posture, species, and tissue properties. The airways are related to each other in a tree hierarchy. To resolve this relationship, the computational fluid dynamic mesh and its operation at upper modeled airways is made generally depending on the lower airways being included in the model but is independent of measurements or other details for the downstream airways. The downstream airways are modeled as distributed through the imaged volume but pressure and flow at the outlets of the modeled airways are inferred from a nominal expectation as to the character of the lower or distal airways.

Because the disclosed method links the 1D and 3D meshes, boundary conditions in the 3D model can be set based on pressure or flow in the 1D model at the location of the interfaces between the 1D and 3D meshes. This aspect makes it possible to predict airflow in a subject with normal or abnormal physiology, and with the lung functioning upright, prone, or supine. For any airway computational fluid dynamic simulation to be commercially or clinically relevant, it must have accurate specification of ‘outlet’ airway boundary conditions.

The disclosed technique links a normalized 1D skeleton of idealized airways to the distal end of a 3D more fully modeled set of airway segments. This is more than a matter of setting all outlet flows or pressures to be identical at the 1D/3D transition. Instead, the volume of the lung from the transition onwardly is virtually filled with the 1D skeletonized passageways using a technique for distributing the passages in the available volume. There can be more or fewer branches and longer or shorter distances proceeding from the 1D/3D junction to the terminal end of different passageways that are parallel at the 1D/3D junction. By determining nominal conditions at the terminal ends of the passageways, the idealized pressure and flow conditions work backward from the terminal ends and may differ at the 1D/3D junction. The boundary conditions for the 3D mesh modeled for computational fluid dynamic aspects is normalized in a sense but also presents a physiologically relevant simulation.

It is another aspect of the disclosed technique that the airways are modeled as elastically expandable structures. In biological subjects, airways may expand or inflate considerably, which has a significant effect on particle transport. The interconnectedness of our models allows calculation of the expanding pressures acting on each individual airway and vessel, and simulation of dynamic volume change.

The elements involved in the present subject-specific computational fluid dynamic systems and methods include CT image acquisition and analysis, geometric modeling of airway trees, 3D and 1D mesh generation areas that are smoothly coupled, 3D and 1D computational fluid dynamic (CFD) methods, and CT-derived physiological boundary conditions for CFD simulations.

In a practical example of an application of the technique, computed tomography (CT) image data were acquired using a Siemens Sensation 64 Multidetector-row CT (MDCT) scanner. Scan parameters were: 120 kV, 100 mAs, pitch 1.2, slice width 0.6 mm, slice interval 0.6 mm. Images consist of a spiral scan of the full lung with inflation level held at 95% vital capacity. Subjects were imaged supine. The MDCT images were processed using the software package “Pulmonary Workstation plus” (PW, VIDA Diagnostics®, Hoffman et al., 1992) to segment the lungs, lobes and intra-thoracic as well as upper airways.

PW is based upon a combination of 3D region growing and 2D mathematical morphology methods. The software has been shown to be capable of extracting airway trees from clinical quality standard-dose MDCT data, and can derive airway wall thickness.

Alternatively, angularly displaced two-dimensional projections of voxel data could be provided on a workstation with position identification pointing devices to identify points on the inside or outside surfaces of an airway. In either case, the point in to determine a set of imaging derived data points to enable customization of an idealized model to match the physiology of the subject. The airway tree is also defined in segments by identifying and storing in memory a skeletonized data set including the centerlines of individual branches the occurrence of and branching points. Centerlines and associated airway structures are labeled, volume and surface area of each segment determined. This is accomplished beginning at the trachea or a bronchus and proceeding through a desired number of branching generations, for example 16 generations. When using PW for this purpose, the software exports the segmented airway geometry to a stereo-lithography (STL) file, which can be used further on in the process.

The airway tree model incorporates anatomical geometric data from the imaged and segmented airways. Also determined are the size and shape of the lungs and lobes. According to an aspect of the disclosed technique, a branching algorithm is run to generate a subject-specific model originating at the imaging based airways. The algorithm continues beyond the passageways defined by imaging and infers a distribution of nominal passageways filling out the size and shape of the lung/lobes. The algorithm places branches along segments at locations that are consistent with the average progression of airways in humans (it can also conform to a morphology typical of sheep). The resulting model is a 1D tree with branches distributed in 3D space. This model is not accurate to the subject at those points along the passageways that are distal to the image-defined segments. The distal points are inferred by the algorithmic generation of a typical distribution of such distal passageways according to nominal characteristics observed in the subject species.

To use the model for computation, diameters must be defined through the entire structure out to the distal ends, including the inferred 1D branches. It is possible to assume initially that the cross-sections of the airways are cylindrical. For the imaging-based (uppermost) airways, diameters are assigned directly by measuring and/or calculating the inside diameter of an airway’ on a line orthogonal to the central axis. The algorithm-based inferred airways for the distal passageways are given assumed diameters using Horsfield or Strahler ordering, weighted against a ratio to parent branch diameter. The ordering and weight force the branches to assume characteristics that are typical of biological lungs.

The physiologically consistent spatial distribution of airways in the 1D tree structure makes it an adequate model for some simulation studies. However, for computing 3D flow and pressure, a 3D structure is defined that incorporates the salient features of the imaged airway geometry. In one embodiment, the 1D tree was converted to a high-order (cubic Hermite) 2D2D surface mesh of the entire domain, where the airway surface is discretized circumferentially and axially. This was achieved by defining a generic bifurcation that is scaled, translated, and rotated automatically to match the position and size of each bifurcation in the 1D tree. At the bifurcations the parent and child branches merge with a smooth, continuous surface. The 2D surface mesh uses high-order elements to represent surface curvature and derivative continuity efficiently.

The mesh is adjusted to match as nearly as practicable the imaged uppermost airways (i.e., the mesh and the airways are geometry fitted). Geometry fitting can include smoothing, so we can manipulate the data fit to smooth out noisy data or fine scale anatomical features, or the smoothing can be relaxed to allow inclusion of geometric detail. The resulting 2D surface mesh has anatomical detail for the imaging-based airway direction and surface geometry. It is continuous with the surface of the algorithm-based airways because their circular diameters were assigned such that they had a morphometrically consistent relationship with the uppermost (imaged) airways.

Any portion of this surface mesh can be converted to a 3D CFD-ready mesh and it would be possible, although a computational burden, to convert the entire mesh. Advantageously, a region of interest is selected for study in detail, for example all airways up to a specified branching generation, or airways that are along a specified path. The 3D mesh is created for those airways only, and for CFD computation including boundary conditions such a pressure and flow, the remainder of the domain is modeled by the original 1D tree, namely the identified passages have lengths between branching points and diameters stored in memory or readily generated by computations.

The 3D and 1D models are not separate structures that are artificially joined together. They are a single integrated model that has a different levels of detail in specified regions. This gives the user a great deal of flexibility in choosing the region to study using detailed computation and perhaps progressing from one region to another.

In the example, open source Gmsh (www.geuz.org/gmsh) software was used to generate tetrahedral meshes within sub-domains throughout the airway tree. Gmsh uses a description of a domain boundary surface, and fills this with an unstructured mesh. The approach is similar to the known method of exporting STL files that represent anatomical surfaces from volumetric imaging, and volume-filling the structure with a tetrahedralized CFD mesh. However in the present method, the intermediate step of creating a high-order 2D surface mesh permits merging of the imaged airway domain with the algorithm-based domain without a discernable difference in the topology of the mesh, which would not be readily possible using STL (or similar) surface geometry descriptions. As a consequence of the systematic structure of the surface mesh, it is possible automatically to divide each volume domain into many small volume meshing subunits for parallel computation.

Both 3D and 1D CFD methods are used for the multi-scale simulations. For 3D flow simulation, a characteristic Galerkin finite element method is applied to solve 3D incompressible, variable-density Navier-Stokes equations. A fractional four-step projection method is employed to enforce mass conservation. To model a breathing lung with compliant airways and moving mesh, the Arbitrary-Lagrangian-Eulerian (ALE) method has been implemented into the 3D model. For capturing turbulent flow, the high fidelity Large-Eddy Simulation (LES) technique can be used. The current LES with a Vreman sub-grid scale model has been validated and verified by several benchmark cases, such as turbulent channel flow that captures accurately the law-of-the-wall mean velocity profile. The 3D CFD model is of second-order accuracy in both time and space, and has been fully parallelized using Message Passing Interface (MPI) for large-scale, high-performance, parallel computation. The 1D flow model is based upon the integral form of continuity and energy equations, i.e. the pressure-flow-resistance approach.

The models are supported by physiologically realistic boundary conditions. In the biological organ, the distribution of ventilation is regionally dependent and driven by expansion of the non-linearly elastic, compressible lung tissue. It may be an oversimplification to assume that the conditions are nominal and equal at the terminal ends of all the passage ways. To prescribe subject-specific and physiologically realistic boundary conditions, it is possible that use: (1) gray-levels in CT images, (2) free form deformation and/or (3) models for the soft tissue deformation of the lung.

In the first image-based method the air content can be calculated for each voxel at both TLC and FRC from the gray-level of the CT images (assuming only lung tissue, blood, and air in the voxel). The flow rate at each of the terminal bronchioles can then be computed using the time rate of change of air volumes between TLC and FRC in the units of two lungs, or five lobes, or parenchymal units surrounding terminal bronchioles. By mass conservation the flow rates at the exit faces of the 3D airway tree model can be determined by summing the flow rates at the terminal bronchioles using the connectivity information (that is embedded in the 3D and 1D coupled mesh) between the 3D exit faces and the associated downstream 1D airway branches.

In the second free-form-deformation method an affine transformation of a host mesh is computed to control the shape change of a structure that is embedded within the host. In one embodiment, a finite element mesh of the lung at TLC was embedded and a small number of anatomical control points were used to compute the transformation to FRC. The transformation tensor can also be used to calculate the change in location and size of the airways—whether in a 1D, 2D, or 3D CFD-ready form. The terminal bronchioles in our model airway trees are each associated with a specific region of tissue, representing a pulmonary acinus. The transformation from TLC to FRC results in a regional, non-uniform volume change that we assume is equivalent to air flow from the peripheral tissue. The local peripheral tissue volume change in a specified time interval is set as a flow boundary condition at the corresponding terminal bronchiole. The connectivity of the multi-scale 3D and 1D model ensures that the boundary conditions are propagated appropriately up the airway tree. Free form deformation is a relatively low cost method to define a volume change with some anatomical basis.

The third soft-tissue-mechanics-based method utilizes a model for the large, non-uniform, elastic deformation of the compressible lung air system. This model is used to calculate local expanding pressures that act on the airways, and the local volume change of the peripheral tissue for setting flow boundary conditions as in the free form deformation method. The model requires definition of its material properties, the direction and magnitude of gravity, and restriction of lung shape to mimic the constraint of a diaphragm and chest wall. In the model the lung is free to slide and the compressible mesh elements can change in volume. Finite deformation elasticity is used to compute stress and strain, therefore the model is appropriate for large strains. By using this model to define the boundary conditions in the coupled airway mesh, gas transport as well as tissue mechanics can be studied at different lung volumes in different orientations.

To study the interaction between air flow and airway wall at a local level and its effects on wall shear stress and implications on airway remodeling and abnormalities, we have developed the FSI technique based upon the above ALE-based CFD method. The FSI technique has been integrated with a finite-volume-based structural dynamics method as well as a finite-element-based structural dynamics method together with a dynamic level-set meshing algorithm. The finite-element structural dynamics method accepts brick and tetrahedron elements for finite-walled structures and shell elements for thin-walled structures like alveoli.

The coupled FSI system is treated as a triple-domain problem that includes the fluid domain, the structure domain, and the moving mesh. The governing equations for both domains are solved in an iterative manner: the Navier-Stokes equations are solved first for the fluid domain. The solutions of the fluid provide external forces including fluid pressure and shear stress to the structure domain.

The dynamics equation is then solved for the structure under the influence of fluid forces, which provides deformation and velocity boundary conditions at the fluid-structure interface. The fluid mesh is moved by the dynamic mesh algorithm in accordance with these boundary conditions, which updates the mesh deformation and ALE velocity for the computation of fluid domain for the next time step. The FSI solvers have been applied to several FSI problems, such as vortex-induced plate vibration, and flow in a 2D or 3D flexible tube, flow in an inflating/contracting balloon, and flow in a human bifurcating compliant airway.

The study of air flow dynamics in the 16-23 generations of human lung (beyond transitional bronchioles) is important for particle transport and provide rich information on deposition sites for particles (e.g. like aerosols) of varying sizes.

The reconstruction of close-to-reality geometry for use in silico and solving for fluid flow under rhythmic breathing are the two crucial stages in understanding the alveolar fluid flow phenomena. The calculation of particle transport and deposition follows more easily once the fluid flow data is available. In the current work, 3D alveoli were reconstructed and visualized as space filling polygonal units using a 3D Voronoi meshing scheme. Alveolar opening angles were 90° and 71° in mutually perpendicular planes. The mouth takes the shape of a non-coplanar hexagon attached to a duct which ventilates fluid uniformly into these cells. Three units share a septa (or common faces) at dihedral angle 120°. The central duct is a space formed within this honeycomb with no distinct walls. An alveolated duct was modeled with 18 alveoli and a central duct. The typical Reynolds number ranges from 1.1-0.04. All CFD simulations have been carried out for a breathing period of 2.5 seconds.

Alveolar flows fall under the category of open cavity flows characterized by interesting flow features like a stagnation point (under steady conditions, attached to the cavity walls near the corner), a recirculation region and flow turning around a sharp corner. The interaction between the cavity and the duct are inhibited by the presence of diffusion-dominated ‘separatrix’ or separation streamline. At even moderate Reynolds numbers, the presence of unsteadiness in the upstream conditions destroys this line. But at low Reynolds number regimes of our interest, due to the absence of inertia, the stagnations points are not destroyed, but oscillate near the corner. Interestingly, in the presence of wall motion (oscillating normal to itself), a portion of slow moving fluid close to the duct entrains the cavity and the recirculation is pushed to one side of the cavity.

The foregoing disclosure provides a computational framework for multi-scale simulation of gas flow in subject-specific airway models of the human lung. The subject matter is disclosed in connection with certain embodiments provided as examples. It should be understood, however, that the invention is not limited to the embodiments disclosed as examples and is capable of variations within the scope of the following claims that define the scope of exclusive rights.

We claim:

1. A method for modeling a branching biological structure comprising:
determining dimensions for a subset of branching passageways in the branching biological structure, the passageways including at least some passageways that are disposed along a flow path between more and less proximal positions in the branching biological structure;
defining a skeleton of relationships for the subset, wherein the branching passageways in the subset are identified by junctions with one another, the skeleton of relationships providing a one dimensional model of passageways and junctions;
further defining at least one of a soft tissue characterization for modeling deformation with force, of at least part of the branching passageways, a two dimensional relationship of relative orientations for the passageways in the subset and a three dimensional surface configuration for the passageways in the subset at least at said junctions;
applying a set of boundary conditions at spaced points in the branching passageways, the boundary conditions comprising values of at least some parameters that influence at least one of pressure, flow, deformation and material present within the branching passageways;
computing resultant conditions in the branching passageways concerning at least one of pressure, flow, deformation and material transport, that are expected to ensue as a result of the boundary conditions; and,
at least one of storing in data memory, displaying, reporting and communicating the resultant conditions.

2. The method of claim 1, further comprising establishing an external envelope of at least a discrete part of the branching biological structure, and modeling the skeleton of relationships from a more proximal position in the branching biological structure substantially to a surface defined by the external envelope.

3. The method of claim 2, comprising determining at least one of the external envelope and measurements of ones of the branching passageways adjacent to the more proximal position by volumetric imaging.

4. The method of claim 3, comprising extracting measurements of said ones of the branching passageways by one of computer tomography and magnetic resonance imaging.

5. The method of claim 4, further comprising inferring nominal conditions for the branching passages that are more distal from said more proximal position.

6. The method of claim 3, further comprising determining the resultant conditions at least partly based on filling a portion of a volume encompassed by the external envelope with nominally modeled terminal elements.

7. The method of claim 6, wherein the biological structure comprises a lobe of a lung and the terminal elements comprise terminal bronchioles.

8. The method of claim 1, wherein the skeleton of relationships comprise a length and an internal diameter for a plurality of the branching passageways in the subset.

9. The method of claim 2, wherein said modeling of the skeleton of relationships from the more proximal position in the branching biological structure substantially to the surface defined by the external envelope comprising assigning a length, and a successively smaller cylindrical diameter to each successive branch of the branching passageways.

10. The method of claim 9, wherein the length and diameter for each said successive branch are related according to a nominal observed relationship for a species.

11. The method of claim 10, further comprising applying a mesh surface to a proximal part of the skeleton, and adjusting the mesh surface to conform to points determined by imaging the branching biological structure.

12. The method of claim 11, further comprising smoothing the mesh surface to conform to the points determined by imaging the branching biological structure.

13. The method of claim 8, further comprising modeling at least one of a wall thickness, a wall compliance and a wall elasticity of the plurality of branching passageways in the subset.

14. The method of claim 9, further comprising computing the resultant conditions before and after a predetermined change in at least one of the branching passageways and the boundary conditions for assessing the change.

15. The method of claim 14, wherein the predetermined change comprises a surgical procedure.

16. The method of claim 13, wherein said modeling comprises applying a time changing variation in at least one of pressure and flow conditions consistent with respiration.

17. The method of claim 16, further comprising generating from said modeling a comparison of at least one of before-and-after conditions separated by an event, subject-to-subject conditions, and species-to-species conditions.

18. The method of claim 17, comprising separately modeling a plurality of subjects for generating the comparison.

19. The method of claim 18, wherein the plurality of subjects comprise at least one subset of a population that is distinct from other subsets of the population according to at least one of physical structure, demographics, age conditioning and disease conditions.

20. A programmed data processing system comprising a processor, a program memory, and data storage operatively coupled to data defining an image of a branching biological structure, wherein:
dimensions for a subset of branching passageways in the branching biological structure are determined, the passageways including at least some passageways that are disposed along a flow path between more and less proximal positions in the branching biological structure;
a skeleton of relationships for the subset is defined and represented in a data memory, wherein the branching passageways in the subset are identified by junctions with one another, the skeleton of relationships providing a one dimensional model of passageways and junctions;
at least one of a soft tissue characterization of deformation with force, a two dimensional relationship of relative orientations for the passageways in the subset and a three dimensional surface configuration for the passageways in the subset at least at said junctions, is generated for at least part of the subset;
a set of boundary conditions are applied at spaced points in the branching passageways, the boundary conditions comprising values of at least some parameters that influence at least one of pressure, flow, deformation and material present within the branching passageways;
resultant conditions are computed concerning at least one of pressure, flow, deformation and material transport that are expected to ensue as a result of the boundary conditions, for points in the branching passageways that are coupled to the spaced points.

21. The data processing system of claim 20, wherein the processor is programmed to operate a model computing variations of at least one of a wall thickness, a wall compliance and a wall elasticity of the plurality of branching passageways in the subset, and wherein the model includes applying a time changing variation in at least one of pressure and flow conditions consistent with respiration.

22. The data processing system of claim 21, wherein the model is applied from a proximal location on the subset to a terminal end of passageways of the skeleton.

23. A program data carrier for storing data that defines a sequence of instructions for execution by a processor coupled to a program memory, and upon execution the processor is thereby caused controllably to process an image of a branching biological structure, and wherein:
dimensions for a subset of branching passageways in the branching biological structure are determined, the passageways including at least some passageways that are disposed along a flow path between more and less proximal positions in the branching biological structure;
a skeleton of relationships for the subset is defined and represented in a data memory, wherein the branching passageways in the subset are identified by junctions with one another, the skeleton of relationships providing a one dimensional model of passageways and junctions;
at least one of a soft tissue characterization representing deformation with force, a two dimensional relationship of relative orientations for the passageways in the subset and a three dimensional surface configuration for the passageways in the subset at least at said junctions, is generated for at least part of the subset;
a set of boundary conditions are applied at spaced points in the branching passageways, the boundary conditions comprising values of at least some parameters that influence at least one of pressure, flow, deformation and material present within the branching passageways;
resultant conditions are computed concerning at least one of pressure, flow, deformation and material transport that are expected to ensue as a result of the boundary conditions, for points in the branching passageways that are coupled to the spaced points.
